(19) United States
(12) Patent Application Publication
(10) Pub. No.: US 2026/0238327 A1
(43) Pub. Date: Aug. 13, 2026

(54) MULTI-PATH RELAYING AND SERVICE CONTINUITY ENHANCEMENTS

(71) Applicant: Intel Corporation, Santa Clara, CA (US)

(72) Inventors: SANGEETHA BANGOLAE, Portland, OR (US); YOUN HYOUNG HEO, Seoul (KR); RAFIA MALIK, Hillsboro, OR (US); ANSAB ALI, Beaverton, OR (US)

(73) Assignee: Intel Corporation, Santa Clara, CA (US)

(21) Appl. No.: 19/148,191

(22) PCT Filed: Feb. 15, 2024
(86) PCT No.: PCT/US24/15938

§ 371 Date: Jul. 15, 2025

Related U.S. Application Data
(60) Provisional application No. 63/485,502, filed on Feb. 16, 2023.

(51) Int. Cl. H04B 7/155; H04W 76/14; H04W 76/15; H04W 76/19

(52) U.S. Cl. CPC H04B 7/155; H04W 76/14; H04W 76/15; H04W 76/19

(57) ABSTRACT

Embodiments attempt to solve challenges in a wireless communications system, such as a cellular system. Embodiments describe various techniques, systems, and devices to support multi-path relay operations for user equipment (UE), such as remote UE and relay UE, as well as base stations such as gNodeB (gNB), in a Third Generation Partnership Project (3GPP) Fifth Generation (5G) New Radio (NR) or Sixth Generation (6G) systems, among other wireless communications systems. Other embodiments are described and claimed.

This application claims the benefit of and priority to previously filed U.S. Provisional Patent Application Ser. No. 63/485,502, filed Feb. 16, 2023, entitled “MULTI-PATH RELAYING WITH IDEAL UE-UE LINK AND SERVICE CONTINUITY ENHANCEMENTS”, which is hereby incorporated by reference in its entirety.

### BACKGROUND

Wireless communication systems are rapidly growing in usage. Further, wireless communication technology has evolved from voice-only communications to also include the transmission of data, such as Internet and multimedia content, to a variety of devices. To accommodate a growing number of devices communicating, many wireless communication systems share the available communication channel resources among devices. Further, Internet-of-Thing (IoT) devices are also growing in usage and can coexist with user devices in various wireless communication systems such as cellular networks.

### BRIEF DESCRIPTION OF THE SEVERAL VIEWS OF THE DRAWINGS

To easily identify the discussion of any particular element or act, the digit or digits in a reference number refer to the figure number in which that element is first introduced.

FIG. 1 illustrates a wireless communications system in accordance with one embodiment.

FIG. 2 illustrates a wireless communications system in accordance with one embodiment.

FIG. 3A illustrates a user plane protocol stack in accordance with one embodiment.

FIG. 3B illustrates a control plane protocol stack in accordance with one embodiment.

FIG. 4 illustrates an operating environment in accordance with one embodiment.

FIG. 5 illustrates a message flow in accordance with one embodiment.

FIG. 6 illustrates a wireless communications system in accordance with one embodiment.

FIG. 7 illustrates an operating environment in accordance with one embodiment.

FIG. 8A illustrates a data schema for UE capability information in accordance with one embodiment.

FIG. 8B illustrates a data schema for UE configuration information in accordance with one embodiment.

FIG. 9A illustrates an apparatus for a remote UE in accordance with one embodiment.

FIG. 9B illustrates an apparatus for a relay UE in accordance with one embodiment.

FIG. 10 illustrates an apparatus for a base station in accordance with one embodiment.

FIG. 11 illustrates a logic flow in accordance with one embodiment.

FIG. 12 illustrates a logic flow in accordance with one embodiment.

FIG. 13 illustrates a logic flow in accordance with one embodiment.

FIG. 14 illustrates a first network in accordance with one embodiment.

FIG. 15 illustrates a second network in accordance with one embodiment.

FIG. 16 illustrates a third network in accordance with one embodiment.

FIG. 17 illustrates a computer readable storage medium in accordance with one embodiment.

### DETAILED DESCRIPTION

The present disclosure provides techniques for implementing multi-path relaying between network devices in a wireless network. In general, multi-path relaying refers to a technique for using multiple communication paths to communicate information between network devices. Each communication path carries the same information for redundancy. A number of communication paths may vary on a given system design and set of design constraints. Based on availability of network resources, the communication paths may utilize different technologies, protocols, radios, radio-frequency (RF) spectrum, and so forth. In some cases, the communication paths may traverse different communication links and/or network devices. This promotes efficient use of scarce network resources while adding resiliency and robustness to ensure the network devices maintain seamless and constant communications. In the event of interference or failure of a first communication path, the network devices may continue communicating using a second communication path, and vice-versa. In this manner, the use of multi-path relay enhances communication reliability, performance, and service continuity between the network devices.

In various embodiments, a communication path refers to a sequence of communication links in a communication system. It represents a physical or logical connectivity between a transmitter of a source device and a receiver of a destination device. A communication link is a physical or logical connection between a pair of network devices. A source device refers to a network device that encodes or transmits information. A destination device refers to a network device that decodes or receives information. A single network device may operate as either a source device or destination device based on an operating mode of the network device at any given moment of time.

In various embodiments, a communication path may comprise a direct path or an indirect path. A direct path utilizes a single communication link between a pair of network devices. For example, the pair of network devices may comprise a source device and a destination device. An indirect path utilizes multiple communication links between a pair of network devices. Further, the indirect path traverses one or more intermediate devices. An intermediate device is any network device arranged to relay information between a source device and a destination device.

In the context of a Third Generation Partnership Project (3GPP) wireless system, examples of network devices may include user equipment (UE), base stations, access points, servers for a core network, and so forth. Examples for a base station may include an eNodeB (eNB), a gNodeB (gNB), and so forth. With respect to multi-path relay, a UE and a base station may establish multiple communication paths between each other for redundancy, reliability, or survivability. For example, the multi-path relay may comprise a first communication path and a second communication path between the UE and the base station. The first communication path may comprise a direct path. A direct path utilizes a single communication link between the UE and the base station. The second communication path may comprise an indirect path. An indirect path utilizes multiple communication links and at least one intermediate node between the UE and the base station.

In one scenario, for example, a first UE and a base station may use a direct path with a single communication link between the first UE and the base station. The first UE and the base station may also use an indirect path with multiple communication links between the first UE and the base station. The multiple communication links may comprise, for example, a first communication link and a second communication link. The first communication link is between the first UE and an intermediate device. The second communication link is between the intermediate device and the base station. The intermediate device, for example, may comprise a second UE different from the first UE. The first UE and the second UE may establish a shorter range device-to-device (D2D) or peer-to-peer (P2P) connection between each other.

In a given operating scenario, the first UE or the base station may operate as a source device or a destination device depending on which device is transmitting a set of information and which device is receiving the set of information. For example, a source device such as the first UE may communicate information with a destination device such as the base station. The first UE transmits a set of information over the direct path. It also transmits a duplicate of the set of information over the indirect path via the second UE. The base station may receive the information and/or the duplicate information.

When both the direct path and the indirect path are active, the base station may receive both the information and the duplicate information, respectively. In this case, the base station uses a de-duplication technique to discard duplicate information and form a single unified set of information. The base station also uses a sequencing technique to ensure the information is received in a correct sequential order, such as a stream of data packets transmitted in a sequential order. When the direct path or the indirect path is inactive, the base station receives the information or the duplicate information. In this case, the base station may also use the sequencing technique to position the received information in a correct sequential order. This same process generally occurs when the source device is the base station that communicates information to the first UE as the destination device.

In some cases, some of the network devices along the direct path and the indirect path may utilize different technologies, protocols, radios, radio-frequency (RF) spectrum, and so forth. For example, a source device and a destination device may establish a first communication path using a first set of wireless communication protocols and a second communication path using a second set of wireless communications protocols. The first set of wireless communication protocols may comprise a wireless protocol stack that is different from a wireless protocol stack of the second set of wireless communication protocols. For example, the first set of wireless communication protocols may be implemented as longer-range wireless protocols and the second set of wireless communication protocols may be implemented as shorter-range wireless protocols. One example of the first set of communication protocols may include one or more cellular protocols, such as 3GPP protocols. One example of the second set of communication protocols may include one or more non-cellular protocols or non-3GPP protocols, such as WiFi, Bluetooth, Zigbee, and so forth. Embodiments are not limited to these examples.

Some examples of longer-range wireless protocols may include several cellular protocols that have been developed and evolved over the years, such as: (1) Second Generation (2G) cellular protocols such as Global System for Mobile Communications (GSM) and Code Division Multiple Access (CDMA), which are protocols focused primarily on voice services and offered limited data capabilities; (2) Third Generation (3G) cellular protocols, such as Universal Mobile Telecommunications System (UMTS) and CDMA2000, which introduced high-speed data services in addition to voice and offered significant improvements in data rates over 2G networks; (3) Fourth Generation (4G) cellular protocols such as Long-Term Evolution (LTE), which provided substantial enhancements in terms of data speeds, capacity, and overall network performance offering faster data rates, lower latency, and improved system efficiency compared to previous generations; (4) Fifth Generation (5G) cellular protocols, such as 5G New Radio (NR), which brings significant advancements in terms of data rates, capacity, latency, and connectivity offering ultra-fast speeds, low latency, massive device connectivity, and support for advanced use cases such as IoT, virtual reality (VR), and autonomous vehicles; and (5) Sixth Generation (6G) cellular protocols, which delivers significantly faster data rates than 5G, potentially reaching terabit-per-second (Tbps) speeds. Embodiments are not limited to these examples.

Some examples of shorter-range wireless protocols may include several non-cellular protocols such as: (1) Institute of Electrical and Electronics Engineers (IEEE) 802.11 standards (e.g., WiFi) for local area network (LAN) connectivity; (2) IEEE 802.15.1 standard (e.g., Bluetooth) designed for personal area networks (PANs) to connect devices such as smartphones, laptops, headphones, and IoT devices; (3) IEEE 802.15.4 standard (e.g., Zigbee) which is a low-power, low-data-rate wireless protocol used for wireless sensor networks (WSNs) and IoT applications; (4) Z-Wave which is a wireless protocol primarily used for smart home automation enabling devices such as smart locks, lighting systems, and thermostats to communicate with a centralized controller; (5) Near Field Communication (NFC) which is a short-range wireless technology used for contactless communication between devices over short distances (typically a few centimeters) and is commonly used for mobile payments, ticketing, information exchange, and other applications that require close proximity communication; (6) Radio Frequency Identification (RFID) which uses radio waves to identify and track objects or individuals for applications like inventory management, access control, electronic toll collection, and asset tracking; (7) long-range for wide-area networks (WANs) (LoRaWAN) in IoT applications which enables long-distance communication with low power consumption, making it suitable for applications like smart cities, agriculture, and utility metering; and (8) Infrared (IR) communication using infrared light to transmit data wirelessly commonly used for remote controls and short-range communication between devices like TVs, audio systems, and other consumer electronics. Embodiments are not limited to these examples.

With respect to multi-path relaying aspects of the present disclosure, a Layer 2 (L2) UE-to-Network (U2N) relaying was defined in 3GPP Release (Rel-17) to support network coverage extension for remote UEs. Support of multi-path with a UE having one direct path to gNB and one indirect path to another UE is being studied and specified in 3GPP Release (Rel-18). While the case when an indirect path is via the L2 U2N relay UE is fairly well studied, the case when the indirect path is via a peer link (e.g., wired, WiFi, etc.) is not yet fully studied and developed. As used herein, the term “peer link” refers to a communication link operating at a theoretical maximum in terms of efficiency or throughput between a pair of network devices, such as a peer-to-peer (P2P) or device-to-device (D2D) communication link between a pair of UEs, for example.

The present disclosure provides techniques and technologies, including transmit and receive operations, for multi-path via an indirect path through a peer link (e.g., wired, WiFi, etc.). This includes the case when the indirect path is via the L2 U2N relay UE as defined by one or more 3GPP standards. The present disclosure also provides support of lossless delivery for inter-gNB path switching scenarios.

The present disclosure discusses the following enhancements for 3GPP multi-path relay, including: (1) enhancements to reliability and throughput of a remote UE when in-coverage of a network node (e.g., gNB); (2) multi-path enhancements (e.g., when the UE is connected to the same gNB using one direct path and one indirect path); (3) enhancements to support lossless delivery and service continuity for inter-gNB path switching scenarios using an L2 U2N relay UE; and (4) enhancements to failure notification for U2U relaying for service continuity support. Other enhancements for 3GPP are described and claimed.

In these and other ways, multiple paths to transport data packets will enable the remote UE to increase its performance. The advanced relaying solutions discussed herein can provide efficiencies for sidelink technology for IoT and/or vehicle-to-anything (V2X) networks, among other types of networks, in terms of resource usage and/or consumption as well as improved user experience.

The following description and the drawings illustrate specific aspects to enable those skilled in the art to practice them. Other aspects may incorporate structural, logical, electrical, process, and other changes. Portions and features of some aspects may be included in, or substituted for, those of other aspects, and are intended to cover available equivalents of the elements described.

The word “example” is used herein to mean “serving as an example, instance, or illustration.” Any aspect or design described herein as “example” is not to be construed as preferred or advantageous over other aspects or designs.

The words “plurality” and “multiple” in the description or the claims expressly refer to a quantity greater than one. The terms “group (of),” “set (of),” “collection (of),” “series (of),” “sequence (of),” “grouping (of),” etc., and the like in the description or in the claims refer to a quantity equal to or greater than one, i.e. one or more. Any term expressed in plural form that does not expressly state “plurality” or “multiple” likewise refers to a quantity equal to or greater than one. The terms “proper subset,” “reduced subset,” and “lesser subset” refer to a subset of a set that is not equal to the set, i.e. a subset of a set that contains less elements than the set.

It is appreciated that any vector or matrix notation utilized herein is example in nature and is employed solely for purposes of explanation. Accordingly, it is understood that the approaches detailed in this disclosure are not limited to being implemented solely using vectors or matrices, and that the associated processes and computations may be equivalently performed with respect to sets, sequences, groups, etc., of data, observations, information, signals, samples, symbols, elements, etc. Furthermore, it is appreciated that references to a “vector” may refer to a vector of any size or orientation, e.g. including a 1×1 vector (e.g. a scalar), a 1×M vector (e.g. a row vector), and an M×1 vector (e.g. a column vector). Similarly, it is appreciated that references to a “matrix” may refer to matrix of any size or orientation, e.g. including a 1×1 matrix (e.g. a scalar), a 1×M matrix (e.g. a row vector), and an M×1 matrix (e.g. a column vector).

As used herein, the term “software” includes any type of executable instruction or set of instructions, including embedded data in the software. Software may also encompass firmware. Software may create, delete or modify software, e.g., through a machine learning process.

A “module” as used herein is understood to include any kind of functionality-implementing entity, which may include hardware-defined modules such as special-purpose hardware, software-defined modules such as a processor executing software or firmware, and mixed modules that include both hardware-defined and software-defined components. A module may thus be an analog circuit or component, digital circuit, mixed-signal circuit or component, logic circuit, processor, microprocessor, Central Processing Unit (CPU), application processor, Graphics Processing Unit (GPU), Digital Signal Processor (DSP), Field Programmable Gate Array (FPGA), integrated circuit, discrete circuit, Application Specific Integrated Circuit (ASIC), etc., or any combination thereof. Any other kind of implementation of the respective functions which will be described below in further detail may also be understood as a “module”. It is understood that any two (or more) of the modules detailed herein may be realized as a single module with substantially equivalent functionality, and conversely that any single module detailed herein may be realized as two (or more) separate modules with substantially equivalent functionality. Additionally, references to a “module” may refer to two or more modules that collectively form a single module.

The term “terminal device” utilized herein includes user-side devices (both mobile and immobile) that may connect to a core network and various external networks via a radio access network. The term “network access node” as utilized herein includes to a network-side device that provides a radio access network with which terminal devices may connect and exchange information with other networks through the network access node.

The term “base station” used in reference to an access node of a mobile communication network may be understood to include a macro base station (such as, for example, for cellular communications), micro/pico/femto base station, Node B, evolved Node-B (base station), Home base station, Remote Radio Head (RRH), relay point, access point (AP, such as, for example, for Wi-Fi, WLAN, WiGig millimeter Wave (mmWave), etc.) etc. As used herein, a “cell” in the setting of telecommunications may be understood to include an area (e.g., a public place) or space (e.g., multi-story building or airspace) served by a base station or access point. The base station may include mobile, e.g., installed in a vehicle, and the covered area or space may move accordingly. Accordingly, a cell may be covered by a set of co-located transmit and receive antennas, which also able to cover and serve a specific sector of the cell. A base station or access point may serve one or more cells, where a cell is characterized by a distinct communication channel or standard (e.g., a base station offering 2G, 3G and LTE services). Macro-, micro-, femto-, pico-cells may have different cell sizes and ranges, and may be static or dynamic (e.g., a cell installed in a drone or balloon) or change its characteristic dynamically (for example, from macrocell to picocell, from static deployment to dynamic deployment, from omnidirectional to directional, from broadcast to narrowcast). Communication channels may include narrowband or broadband. Communication channels may also use carrier aggregation across radio communication technologies and standards, or flexibly adapt bandwidth to communication needs. In addition, terminal devices may include or act as base stations or access points or relays or other network access nodes.

The term “network” as utilized herein, for example, in reference to a communication network such as a mobile communication network, encompasses both an access section of a network (e.g., a radio access network (RAN) section) and a core section of a network (e.g., a core network section), but also, for an end-to-end system, encompasses mobile (including peer-to-peer, device to device, or machine to machine communications), access, backhaul, server, backbone and gateway/interchange elements to other networks of the same or different type. The term “radio idle mode” or “radio idle state” used herein in reference to a mobile terminal refers to a radio control state in which the mobile terminal is not allocated one dedicated communication channel of a mobile communication network. The term “radio connected mode” or “radio connected state” used in reference to a mobile terminal refers to a radio control state in which the mobile terminal is allocated one dedicated uplink communication channel of a mobile communication network. The uplink communication channel may be a physical channel or a virtual channel. Idle or connection mode may be connection-switched or packet-switched.

Unless explicitly specified, the term “transmit” encompasses both direct (point-to-point) and indirect transmission (via one or more intermediary points or nodes). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of logical data over a software-level connection). For example, a processor may transmit or receive data in the form of radio signals with another processor, where the physical transmission and reception is handled by radio-layer components such as RF transceivers and antennas, and the logical transmission and reception is performed by the processor. The term “communicate” encompasses one or both of transmitting and receiving i.e. unidirectional or bidirectional communication in one or both of the incoming and outgoing directions. The term “calculate” encompasses both ‘direct’ calculations via a mathematical expression/formula/relationship and ‘indirect’ calculations via lookup or hash tables and other array indexing or searching operations.

Some of the features in this document are defined for the network side, such as Access Points, eNodeBs, New Radio (NR) or next generation Node Bs (gNodeB or gNB note that this term is typically used in the context of 3GPP fifth generation (5G) communication systems), etc. Still, a User Equipment (UE) may take this role as well and act as an Access Points, eNodeBs, gNodeBs, etc. I.e., some features defined for network equipment may be implemented by a UE.

As used herein, the term “circuitry” may refer to, be part of, or include a circuit, an integrated circuit (IC), a monolithic IC, a discrete circuit, a hybrid integrated circuit (HIC), an Application Specific Integrated Circuit (ASIC), an electronic circuit, a logic circuit, a microcircuit, a hybrid circuit, a microchip, a chip, a chiplet, a chipset, a multi-chip module (MCM), a semiconductor die, a system on a chip (SoC), a processor (shared, dedicated, or group), a processor circuit, a processing circuit, or associated memory (shared, dedicated, or group) operably coupled to the circuitry that execute one or more software or firmware programs, a combinational logic circuit, or other suitable hardware components that provide the described functionality. In some embodiments, the circuitry may be implemented in, or functions associated with the circuitry may be implemented by, one or more software or firmware modules. In some embodiments, circuitry may include logic, partially operable in hardware.

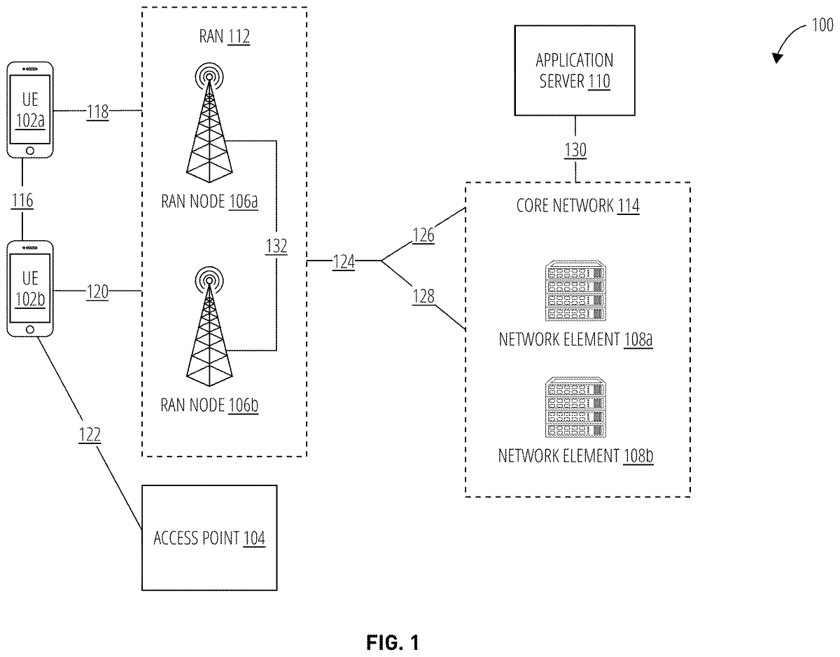

FIG. 1 illustrates an example of a wireless communication wireless communications system 100. For purposes of convenience and without limitation, the example wireless communications system 100 is described in the context of the long-term evolution (LTE) and fifth generation (5G) new radio (NR) (5G NR) or sixth generation (6G) cellular networks communication standards, such as 3GPP Technical Specification (TS) 38.300 titled “Technical Specification Group Radio Access Network; NR; NR and NG-RAN Overall Description; Stage 2,” Release 17 and Release 18, Jan. 12, 2024(3GPP TS 38.300 Standards), 3GPP TS 38.331 titled “Technical Specification Group Radio Access Network; NR; Radio Resource Control (RRC) protocol specification,” Release 17 and Release 18, Jan. 15, 2024 (3GPP TS 38.331 Standards), or other 3GPP standards or specifications. However, other types of wireless standards are possible as well.

With respect to the 3GPP TS 38.300 Standards, the 3GPP Technical Specification Group (TSG) Radio Access Network (RAN) (TSG-RAN) Working Group 2 (WG2) (RAN2) proposed a Change Request (CR) 0771, Revision 3, for 3GPP TS 38.300 Version 17.6.0 titled “Introduction of NR sidelink relay enhancements,” number R2-2314074, November 2023 (CR 0771). CR 0771 introduces NR sidelink relay enhancements including sidelink UE-to-UE (U2U) relay, UE-to-Network (U2N) service continuity enhancement and multi-path relay. CR 0771 also introduces support of L2 U2U relay functionality including L2 U2U relay discovery and selection or re-selection. CR 0771 further introduces a control plane procedure for supporting U2U relay operation. Inter-gNB path switching from direct to indirect, inter-gNB path switching from direct-to-indirect and inter/intra-gNB path switching from indirect to indirect are introduced to support service continuity enhancement. The 3GPP TSG-RAN Working Group 3 (WG 3) (RAN 3) endorsed CR (i.e. R3-238113) is accommodated to support inter-gNB path switching. The support of multi-path relay functionality having sidelink indirect path or non-3GPP indirect path is introduced. NR sidelink relay enhancements for sidelink UE-to-UE relay, service continuity, and multi-path operation are not supported in NR.

To implement multi-path relaying, as defined by various 3GPP standards, a network device such as a UE can implement various types of functionality to support multi-path relaying operations. In various embodiments, a UE may be configured with functionality to operate as a UE-to-Network (U2N) relay UE, a U2N remote UE, a UE-to-UE (U2U) relay UE, a U2U remote UE, a Multi-Path (MP) relay UE, a MP remote UE, and so forth. A U2N Relay UE is a UE that provides functionality to support connectivity to the network for U2N Remote UE(s). A U2N Remote UE is a UE that communicates with the network via a U2N Relay UE. A U2U Relay UE is a UE that provides functionality to support connectivity between two U2U Remote UEs. A U2U Remote UE is a UE that communicates with other UE(s) via a U2U Relay UE. An MP Relay UE is a UE that provides functionality to support connectivity to the network for MP Remote UE(s). An MP Remote UE is a UE that communicates with the network via a direct Uu link and a MP Relay UE. Embodiments that use the more general term “remote UE” and “relay UE” may be applicable to all types of UE to support MP operations. Similarly, embodiments that use a specific term such as “U2N” or “U2U” or “MP” as a prefix for a UE may be applicable to all types of UE to support MP operations. In some cases, embodiments may use a prefix such as Layer 2 (L2) or Layer 3 (L3), which refer to corresponding layers in a network protocol stack, such as a 3GPP protocol stack or a non-3GPP protocol stack. Embodiments are not limited to these examples of network devices to support MP operations.

FIG. 1 illustrates a representative cellular system implementing one or more 3GPP standards. As depicted in FIG. 1, the wireless communications system 100 supports two classes of UE devices, including a reduced capability (RedCap) UE 102a and standard UE 102b (collectively referred to as the “UEs 102”). In one embodiment, the UE 102a may have a set of one or more reduced capabilities relative to a set of standard capabilities of the standard UE 102b. Examples of reduced capabilities may include without limitation: (1) 20 megahertz (MHz) in sub-7 gigahertz (GHz) or 100 MHz in millimeter wave (mmWave) frequency bands; (2) a single transmit (Tx) antenna (1 Tx); (3) a single receive (Rx) antenna (1 Rx), with 2 antennas (2 Rx) being optional; (4) optional support for half-duplex FDD; (5) lower-order modulation, with 256-quadrature amplitude modulation (QAM) being optional; and (6) support for lower transmit power. In one embodiment, for example, the standard UE 102b may have a 2 Rx antenna, while the UE 102a may only have a 1 Rx antenna. The UE 102a may have other reduced capabilities as well. Embodiments are not limited in this context.

In this example, the UEs 102 are illustrated as smartphones (e.g., handheld touchscreen mobile computing devices connectable to one or more cellular networks). In other examples, any of the UEs 102 can include other mobile or non-mobile computing devices, such as consumer electronics devices, cellular phones, smartphones, feature phones, tablet computers, wearable computer devices, personal digital assistants (PDAs), pagers, wireless handsets, desktop computers, laptop computers, in-vehicle infotainment (IVI), in-car entertainment (ICE) devices, an Instrument Cluster (IC), head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, machine-type communications (MTC) devices, machine-to-machine (M2M) devices, Internet of Things (IOT) devices, or combinations of them, among others.

In some implementations, any of the UEs 102 may be IoT UEs, which can include a network access layer designed for low-power IoT applications utilizing short-lived UE connections. An IoT UE can utilize technologies such as M2M or MTC for exchanging data with an MTC server or device using, for example, a public land mobile network (PLMN), proximity services (ProSe), device-to-device (D2D) communication, sensor networks, IoT networks, or combinations of them, among others. The M2M or MTC exchange of data may be a machine-initiated exchange of data. An IoT network describes interconnecting IoT UEs, which can include uniquely identifiable embedded computing devices (within the Internet infrastructure), with short-lived connections. The IoT UEs may execute background applications (e.g., keep-alive messages or status updates) to facilitate the connections of the IoT network.

The UEs 102 are configured to connect (e.g., communicatively couple) with a radio access network (RAN) 112. In some implementations, the RAN 112 may be a next generation RAN (NG RAN), an evolved UMTS terrestrial radio access network (E-UTRAN), or a legacy RAN, such as a UMTS terrestrial radio access network (UTRAN) or a GSM EDGE radio access network (GERAN). As used herein, the term “NG RAN” may refer to a RAN 112 that operates in a 5G NR wireless communications system 100, and the term “E-UTRAN” may refer to a RAN 112 that operates in an LTE or 4G wireless communications system 100.

To connect to the RAN 112, the UEs 102 utilize connections (or channels) 118 and 120, respectively, each of which can include a physical communications interface or layer, as described below. In this example, the connections 118 and 120 are illustrated as an air interface to enable communicative coupling, and can be consistent with cellular communications protocols, such as a global system for mobile communications (GSM) protocol, a code-division multiple access (CDMA) network protocol, a push-to-talk (PTT) protocol, a PTT over cellular (POC) protocol, a universal mobile telecommunications system (UMTS) protocol, a 3GPP LTE protocol, a 5G NR protocol, or combinations of them, among other communication protocols.

The UE 102b is shown to be configured to access an access point (AP) 104 (also referred to as “WLAN node 104,” “WLAN 104,” “WLAN Termination 104,” “WT 104” or the like) using a connection 122. The connection 122 can include a local wireless connection, such as a connection consistent with any IEEE 802.11 protocol, in which the AP 104 would include a wireless fidelity (Wi-Fi) router. In this example, the AP 104 is shown to be connected to the Internet without connecting to the core network of the wireless system, as described in further detail below.

The RAN 112 can include one or more nodes such as RAN nodes 106a and 106b (collectively referred to as “RAN nodes 106” or “RAN node 106”) that enable the connections 118 and 120. As used herein, the terms “access node,” “access point,” or the like may describe equipment that provides the radio baseband functions for data or voice connectivity, or both, between a network and one or more users. These access nodes can be referred to as base stations (BS), gNodeBs, gNBs, eNodeBs, eNBs, NodeBs, RAN nodes, rode side units (RSUs), transmission reception points (TRxPs or TRPs), and the link, and can include ground stations (e.g., terrestrial access points) or satellite stations providing coverage within a geographic area (e.g., a cell), among others. As used herein, the term “NG RAN node” may refer to a RAN node 106 that operates in an 5G NR wireless communications system 100 (for example, a gNB), and the term “E-UTRAN node” may refer to a RAN node 106 that operates in an LTE or 4G wireless communications system 100 (e.g., an eNB). In some implementations, the RAN nodes 106 may be implemented as one or more of a dedicated physical device such as a macrocell base station, or a low power (LP) base station for providing femtocells, picocells or other like cells having smaller coverage areas, smaller user capacity, or higher bandwidth compared to macrocells.

In some implementations, some or all of the RAN nodes 106 may be implemented as one or more software entities running on server computers as part of a virtual network, which may be referred to as a cloud RAN (CRAN) or a virtual baseband unit pool (vBBUP). The CRAN or vBBUP may implement a RAN function split, such as a packet data convergence protocol (PDCP) split in which radio resource control (RRC) and PDCP layers are operated by the CRAN/vBBUP and other layer two (e.g., data link layer) protocol entities are operated by individual RAN nodes 106; a medium access control (MAC)/physical layer (PHY) split in which RRC, PDCP, MAC, and radio link control (RLC) layers are operated by the CRAN/vBBUP and the PHY layer is operated by individual RAN nodes 106; or a “lower PHY” split in which RRC, PDCP, RLC, and MAC layers and upper portions of the PHY layer are operated by the CRAN/vBBUP and lower portions of the PHY layer are operated by individual RAN nodes 106. This virtualized framework allows the freed-up processor cores of the RAN nodes 106 to perform, for example, other virtualized applications. In some implementations, an individual RAN node 106 may represent individual gNB distributed units (DUs) that are connected to a gNB central unit (CU) using individual F1 interfaces (not shown in FIG. 1). In some implementations, the gNB-DUs can include one or more remote radio heads or RFEMs, and the gNB-CU may be operated by a server that is located in the RAN 112 (not shown) or by a server pool in a similar manner as the CRAN/vBBUP. Additionally, or alternatively, one or more of the RAN nodes 106 may be next generation eNBs (ng-eNBs), including RAN nodes that provide E-UTRA user plane and control plane protocol terminations toward the UEs 102, and are connected to a 5G core network (e.g., core network 114) using a next generation interface.

In vehicle-to-everything (V2X) scenarios, one or more of the RAN nodes 106 may be or act as RSUs. The term “Road Side Unit” or “RSU” refers to any transportation infrastructure entity used for V2X communications. A RSU may be implemented in or by a suitable RAN node or a stationary (or relatively stationary) UE, where a RSU implemented in or by a UE may be referred to as a “UE-type RSU,” a RSU implemented in or by an eNB may be referred to as an “eNB-type RSU,” a RSU implemented in or by a gNB may be referred to as a “gNB-type RSU,” and the like. In some implementations, an RSU is a computing device coupled with radio frequency circuitry located on a roadside that provides connectivity support to passing vehicle UEs 102 (VUEs 102). The RSU may also include internal data storage circuitry to store intersection map geometry, traffic statistics, media, as well as applications or other software to sense and control ongoing vehicular and pedestrian traffic. The RSU may operate on the 5.9 GHZ Direct Short Range Communications (DSRC) band to provide very low latency communications required for high speed events, such as crash avoidance, traffic warnings, and the like. Additionally, or alternatively, the RSU may operate on the cellular V2X band to provide the aforementioned low latency communications, as well as other cellular communications services. Additionally, or alternatively, the RSU may operate as a Wi-Fi hotspot (2.4 GHz band) or provide connectivity to one or more cellular networks to provide uplink and downlink communications, or both. The computing device(s) and some or all of the radiofrequency circuitry of the RSU may be packaged in a weatherproof enclosure suitable for outdoor installation, and can include a network interface controller to provide a wired connection (e.g., Ethernet) to a traffic signal controller or a backhaul network, or both.

Any of the RAN nodes 106 can terminate the air interface protocol and can be the first point of contact for the UEs 102. In some implementations, any of the RAN nodes 106 can fulfill various logical functions for the RAN 112 including, but not limited to, radio network controller (RNC) functions such as radio bearer management, uplink and downlink dynamic radio resource management and data packet scheduling, and mobility management.

In some implementations, the UEs 102 can be configured to communicate using orthogonal frequency division multiplexing (OFDM) communication signals with each other or with any of the RAN nodes 106 over a multicarrier communication channel in accordance with various communication techniques, such as, but not limited to, OFDMA communication techniques (e.g., for downlink communications) or SC-FDMA communication techniques (e.g., for uplink communications), although the scope of the techniques described here not limited in this respect. The OFDM signals can comprise a plurality of orthogonal subcarriers.

The RAN nodes 106 can transmit to the UEs 102 over various channels. Various examples of downlink communication channels include Physical Broadcast Channel (PBCH), Physical Downlink Control Channel (PDCCH), and Physical Downlink Shared Channel (PDSCH). Other types of downlink channels are possible. The UEs 102 can transmit to the RAN nodes 106 over various channels. Various examples of uplink communication channels include Physical Uplink Shared Channel (PUSCH), Physical Uplink Control Channel (PUCCH), and Physical Random Access Channel (PRACH). Other types of uplink channels are possible.

In some implementations, a downlink resource grid can be used for downlink transmissions from any of the RAN nodes 106 to the UEs 102, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements; in the frequency domain, this may represent the smallest quantity of resources that currently can be allocated. There are several different physical downlink channels that are conveyed using such resource blocks.

The PDSCH carries user data and higher-layer signaling to the UEs 102. The PDCCH carries information about the transport format and resource allocations related to the PDSCH channel, among other things. It may also inform the UEs 102 about the transport format, resource allocation, and hybrid automatic repeat request (HARQ) information related to the uplink shared channel. Downlink scheduling (e.g., assigning control and shared channel resource blocks to the UE 102b within a cell) may be performed at any of the RAN nodes 106 based on channel quality information fed back from any of the UEs 102. The downlink resource assignment information may be sent on the PDCCH used for (e.g., assigned to) each of the UEs 102.

The PDCCH uses control channel elements (CCEs) to convey the control information. Before being mapped to resource elements, the PDCCH complex-valued symbols may first be organized into quadruplets, which may then be permuted using a sub-block interleaver for rate matching. In some implementations, each PDCCH may be transmitted using one or more of these CCEs, in which each CCE may correspond to nine sets of four physical resource elements collectively referred to as resource element groups (REGs). Four Quadrature Phase Shift Keying (QPSK) symbols may be mapped to each REG. The PDCCH can be transmitted using one or more CCEs, depending on the size of the downlink control information (DCI) and the channel condition. In LTE, there can be four or more different PDCCH formats defined with different numbers of CCEs (e.g., aggregation level, L=1, 2, 4, or 8).

Some implementations may use concepts for resource allocation for control channel information that are an extension of the above-described concepts. For example, some implementations may utilize an enhanced PDCCH (EPDCCH) that uses PDSCH resources for control information transmission. The EPDCCH may be transmitted using one or more enhanced CCEs (ECCEs). Similar to above, each ECCE may correspond to nine sets of four physical resource elements collectively referred to as an enhanced REG (EREG). An ECCE may have other numbers of EREGs.

The RAN nodes 106 are configured to communicate with one another using an interface 132. In examples, such as where the wireless communications system 100 is an LTE system (e.g., when the core network 114 is an evolved packet core (EPC) network), the interface 132 may be an X2 interface 132. The X2 interface may be defined between two or more RAN nodes 106 (e.g., two or more eNBs and the like) that connect to the EPC 114, or between two eNBs connecting to EPC 114, or both. In some implementations, the X2 interface can include an X2 user plane interface (X2-U) and an X2 control plane interface (X2-C). The X2-U may provide flow control mechanisms for user data packets transferred over the X2 interface, and may be used to communicate information about the delivery of user data between eNBs. For example, the X2-U may provide specific sequence number information for user data transferred from a master eNB to a secondary eNB; information about successful in sequence delivery of PDCP protocol data units (PDUs) to a UE 102 from a secondary eNB for user data; information of PDCP PDUs that were not delivered to a UE 102; information about a current minimum desired buffer size at the secondary eNB for transmitting to the UE user data, among other information. The X2-C may provide intra-LTE access mobility functionality, including context transfers from source to target eNBs or user plane transport control; load management functionality; inter-cell interference coordination functionality, among other functionalities.

In some implementations, such as where the wireless communications system 100 is a 5G NR system (e.g., when the core network 114 is a 5G core network), the interface 132 may be an Xn interface 132. The Xn interface may be defined between two or more RAN nodes 106 (e.g., two or more gNBs and the like) that connect to the 5G core network 114, between a RAN node 106 (e.g., a gNB) connecting to the 5G core network 114 and an eNB, or between two eNBs connecting to the 5G core network 114, or combinations of them. In some implementations, the Xn interface can include an Xn user plane (Xn-U) interface and an Xn control plane (Xn-C) interface. The Xn-U may provide non-guaranteed delivery of user plane PDUs and support/provide data forwarding and flow control functionality. The Xn-C may provide management and error handling functionality, functionality to manage the Xn-C interface; mobility support for UE 102 in a connected mode (e.g., CM-CONNECTED) including functionality to manage the UE mobility for connected mode between one or more RAN nodes 106, among other functionalities. The mobility support can include context transfer from an old (source) serving RAN node 106 to new (target) serving RAN node 106, and control of user plane tunnels between old (source) serving RAN node 106 to new (target) serving RAN node 106. A protocol stack of the Xn-U can include a transport network layer built on Internet Protocol (IP) transport layer, and a GPRS tunneling protocol for user plane (GTP-U) layer on top of a user datagram protocol (UDP) or IP layer(s), or both, to carry user plane PDUs. The Xn-C protocol stack can include an application layer signaling protocol (referred to as Xn Application Protocol (Xn-AP or XnAP)) and a transport network layer (TNL) that is built on a stream control transmission protocol (SCTP). The SCTP may be on top of an IP layer, and may provide the guaranteed delivery of application layer messages. In the transport IP layer, point-to-point transmission is used to deliver the signaling PDUs. In other implementations, the Xn-U protocol stack or the Xn-C protocol stack, or both, may be same or similar to the user plane and/or control plane protocol stack(s) shown and described herein.

The RAN 112 is shown to be communicatively coupled to a core network 114 (referred to as a “CN 114”). The CN 114 includes multiple network elements, such as network element 108a and network element 108b (collectively referred to as the “network elements 108”), which are configured to offer various data and telecommunications services to customers/subscribers (e.g., users of UEs 102) who are connected to the CN 114 using the RAN 112. The components of the CN 114 may be implemented in one physical node or separate physical nodes and can include components to read and execute instructions from a machine-readable or computer-readable medium (e.g., a non-transitory machine-readable storage medium). In some implementations, network functions virtualization (NFV) may be used to virtualize some or all of the network node functions described here using executable instructions stored in one or more computer-readable storage mediums, as described in further detail below. A logical instantiation of the CN 114 may be referred to as a network slice, and a logical instantiation of a portion of the CN 114 may be referred to as a network sub-slice. NFV architectures and infrastructures may be used to virtualize one or more network functions, alternatively performed by proprietary hardware, onto physical resources comprising a combination of industry-standard server hardware, storage hardware, or switches. In other words, NFV systems can be used to execute virtual or reconfigurable implementations of one or more network components or functions, or both.

An application server 110 may be an element offering applications that use IP bearer resources with the core network (e.g., UMTS packet services (PS) domain, LTE PS data services, among others). The application server 110 can also be configured to support one or more communication services (e.g., VoIP sessions, PTT sessions, group communication sessions, social networking services, among others) for the UEs 102 using the CN 114. The application server 110 can use an IP communications interface 130 to communicate with one or more network elements 108a.

In some implementations, the CN 114 may be a 5G core network (referred to as “5GC 114” or “5G core network 114”), and the RAN 112 may be connected with the CN 114 using a next generation interface 124. In some implementations, the next generation interface 124 may be split into two parts, a next generation user plane (NG-U) interface 114, which carries traffic data between the RAN nodes 106 and a user plane function (UPF), and the S1 control plane (NG-C) interface 126, which is a signaling interface between the RAN nodes 106 and access and mobility management functions (AMFs). Examples where the CN 114 is a 5G core network are discussed in more detail with regard to later figures.

In some implementations, the CN 114 may be an EPC (referred to as “EPC 114” or the like), and the RAN 112 may be connected with the CN 114 using an S1 interface 124. In some implementations, the S1 interface 124 may be split into two parts, an S1 user plane (S1-U) interface 128, which carries traffic data between the RAN nodes 106 and the serving gateway (S-GW), and the S1-MME interface 126, which is a signaling interface between the RAN nodes 106 and mobility management entities (MMEs).

With respect to multi-path relaying aspects of the present disclosure, an L2 UE-to-NW (U 2N) relaying was defined in 3GPP Release (Rel-17) to support network coverage extension for remote UEs. Support of multi-path with a UE having one direct path to gNB and one indirect path to another UE is being studied and specified in 3GPP Release (Rel-18). While the case when an indirect path is via the L2 U2N relay UE is fairly well defined, the case when the indirect path is via a peer link (e.g., wired, WiFi, etc.) is not yet fully studied and developed. As used herein, the term “peer link” refers to a communication link operating at a theoretical maximum in terms of efficiency or throughput between a pair of network devices, such as a P2P or D2D communication link between a pair of UEs, for example.

The present disclosure provides techniques and technologies, including transmit and receive operations, for multi-path via indirect path is via a peer link (e.g., wired, WiFi, etc.). For the case when indirect path is via the L2 U2N relay UE. The present disclosure also provides support of lossless delivery for inter-gNB path switching scenarios.

The present disclosure discusses the following enhancements for Rel-18 multi-path relay, including: (1) enhancements to reliability and throughput of a remote UE when in-coverage of a network node (e.g., gNB); (2) multi-path enhancements (e.g., when the UE is connected to the same gNB using one direct path and one indirect path); (3) enhancements to support lossless delivery and service continuity for inter-gNB path switching scenarios using an L2 U2N Relay UE; and (4) enhancements to failure notification for U2U relaying for service continuity support. Other enhancements for Rel-18 are described and claimed.

In these and other ways, multiple paths to transport data packets will enable the remote UE to increase its performance. The advanced relaying solutions discussed herein can provide efficiencies for sidelink technology for IoT and/or vehicle-to-anything (V2X) networks, among other types of networks, in terms of resource usage and/or consumption as well as improved user experience.

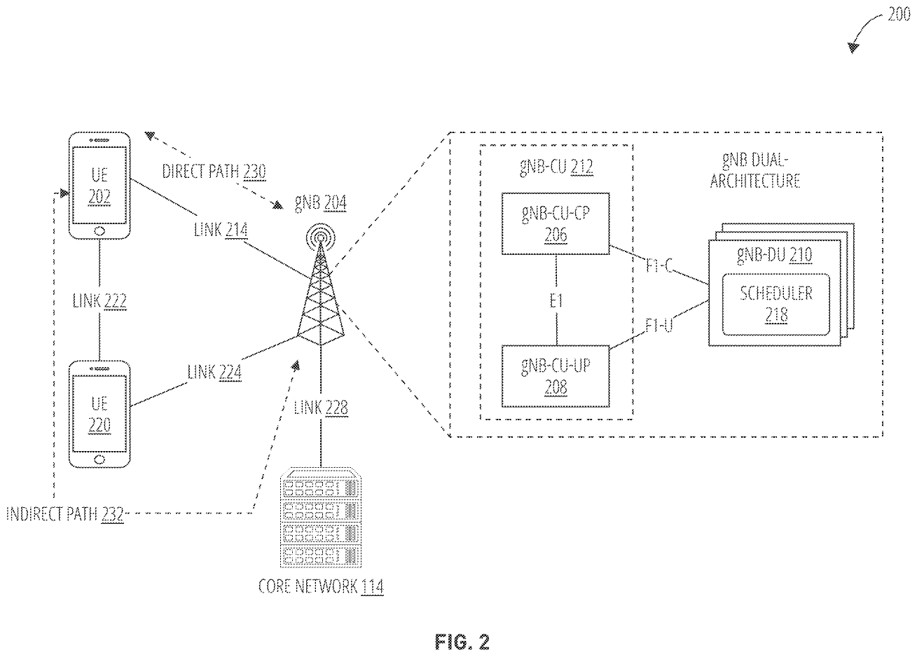

As previously discussed, in some implementations, an individual RAN node 106 may be implemented as a gNB dual-architecture comprising multiple gNB-DUs that are connected to a gNB-CU using individual F1 interfaces. An example of a gNB dual-architecture for a RAN node 106 is shown in FIG. 2.

FIG. 2 illustrates wireless communications system 200. The wireless communications system 200 is a sub-system of the wireless communications system 100 illustrated in FIG. 1. The wireless communications system 200 depicts a UE 202 connected to a gNB 204 over a connection 214. The UE 202 and connection 214 are similar to the UE 102 and the connections 118, 120 described with reference to FIG. 1. The gNB 204 is similar to the RAN node 106, and represents an implementation of the RAN node 106 as a gNB with a dual-architecture.

As depicted in FIG. 2, the gNB 204 is divided into two physical entities referred to a centralized or central unit (CU) and a distributed unit (DU). The gNB 204 may comprise a gNB-CU 212 and one or more gNB-DU 210. The gNB-CU 212 is further divided into a gNB-CU control plane (gNB-CU-CP) 206 and a gNB-CU user plane (gNB-CU-UP) 208. The gNB-CU-CP 206 and the gNB-CU-UP 208 communicate over an El interface. The gNB-CU-CP 206 communicates with one or more gNB-DU 210 over an F1-C interface. The gNB-CU-UP 208 communicates with the one or more gNB-DU 210 over an F1-U interface.

In some implementations, there is a single gNB-CU 212 for each gNB 204 that controls multiple gNB-DU 210. For example, the gNB 204 may have more than 100 gNB-DU 210 connected to a single gNB-CU 212. Each gNB-DU 210 is able to support one or more cells, where one gNB 204 can potentially control hundreds of cells in a 5G NR system.

The gNB-CU 212 is mainly involved in controlling and managing the overall network operations, performing tasks related to the control plane, such as connection establishment, mobility management, and signaling. It is responsible for non-real-time functionalities, which include policy decisions, routing, and session management among others. The gNB-CU-CP 206 and the gNB-CU-UP 208 provides support for higher layers of a protocol stack such as Service Data Adaptation Protocol (SDAP), Packet Data Convergence Protocol (PDCP) and RRC.

The gNB-DU 210 is responsible for real-time, high-speed functions, such as the scheduling of radio resources, managing the data plane, and performing error handling and retransmissions. The gNB-DU 210 provides support for lower layers of the protocol stack such as Radio Link Control (RLC), MAC layer, and PHY layer.

As depicted in FIG. 2, the gNB-DU 210 includes a scheduler 218. In order to utilize radio resources efficiently, a MAC in gNB 204 includes dynamic resource schedulers that allocate physical layer resources for the downlink and the uplink. In the wireless communications system 100 and/or the wireless communications system 200, scheduling of communication paths and/or communication links for UE 202, including their configuration and allocation, is primarily handled by the base station of the serving cell, by the scheduler 218. The scheduler 218 is involved in real-time operations and is responsible for making immediate decisions regarding the allocation of radio resources for communication paths or communication links, managing interference, and adhering to Quality of Service (QOS) requirements for different services and users. The scheduler 218 within the gNB-DU 210 makes decisions about resource allocation, including when and how to schedule communication paths and/or communication links for the UE 202. It considers the capabilities of the UE 202, mobility state, quality of service requirements, and current network conditions, among other factors.

Although the scheduler 218 is located within the gNB-DU, it frequently interacts with the gNB-CU. The gNB-CU provides the necessary control and configuration information to the gNB-DU, which it uses to make real-time scheduling decisions and manage radio resources effectively. The configuration, policies, and user-specific QoS parameters provided by the gNB-CU aid the scheduler 218 in the gNB-DU to allocate resources and manage user traffic efficiently, catering to diverse service requirements in 5G and 6G networks.

With respect to NR sidelink relay enhancements, the architecture for multi-path transmission using two communication paths, e.g., a direct path 230 and an indirect path 232, is shown by FIG. 2. This scenario has a potential to improve the reliability and/or robustness as well as throughput, so it is being considered as an enhancement area in 3GPP Rel-18 work item. This multi-path relay solution is for UE aggregation where a UE is connected to the network via direct path 230 and indirect path 232 via another UE using a non-standardized UE-UE interconnection. UE aggregation aims to provide applications requiring high uplink (UL) bitrates on 5G terminals, in cases when normal UEs are too limited by UL UE transmission power to achieve a defined bitrate, especially at the edge of a cell. Additionally, UE aggregation can improve the reliability, stability and reduce delay of services as well, that is, if the channel condition of a terminal is deteriorating, another terminal can be used to make up for the traffic performance unsteadiness caused by channel condition variation.

As depicted in FIG. 2, the UE 202 or the UE 220 may be configured to operate as a source device, and the gNB 204 as a destination device, or vice-versa. For example, assume the UE 202 is a remote UE. The UE 202 may connect to the gNB 204 using a direct path 230 via a communication link 214, such as a Uu link, for example. The UE 202 may also connect to the gNB 204 using an indirect path 232 via a first communication link 222, such as a U2U link, for example. The indirect path 232 may also include a second communication link 224, such as a Uu link, for example. In turn, the gNB 204 may communicate with the core network 114 via the communication link 228, such as an N2/N3 link. This configuration is sometimes referred to as a “multi-path scenario 2” for multi-path in RAN2 and in the multi-path discussion in 3GPP Rel-18 work and in the present disclosure.

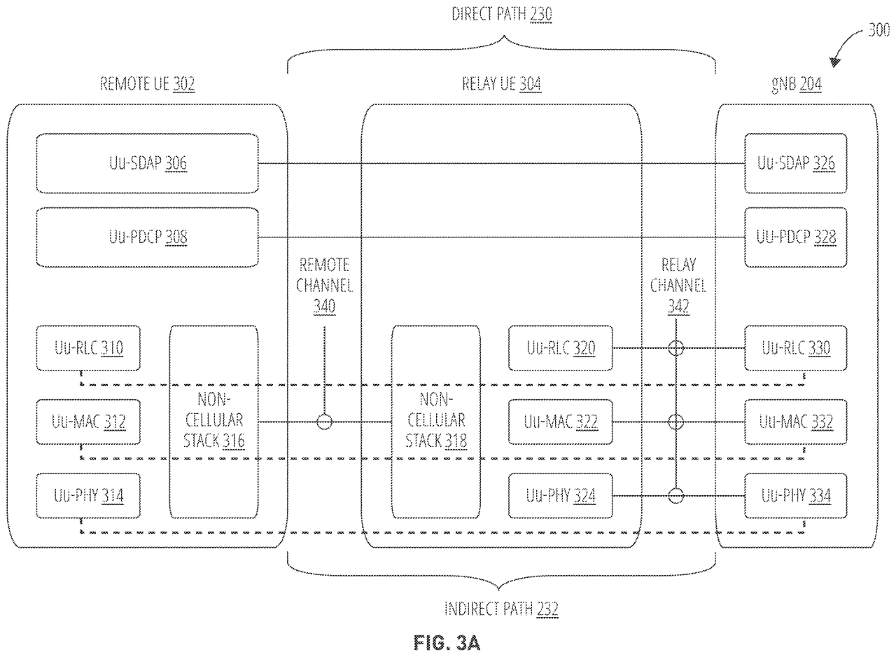

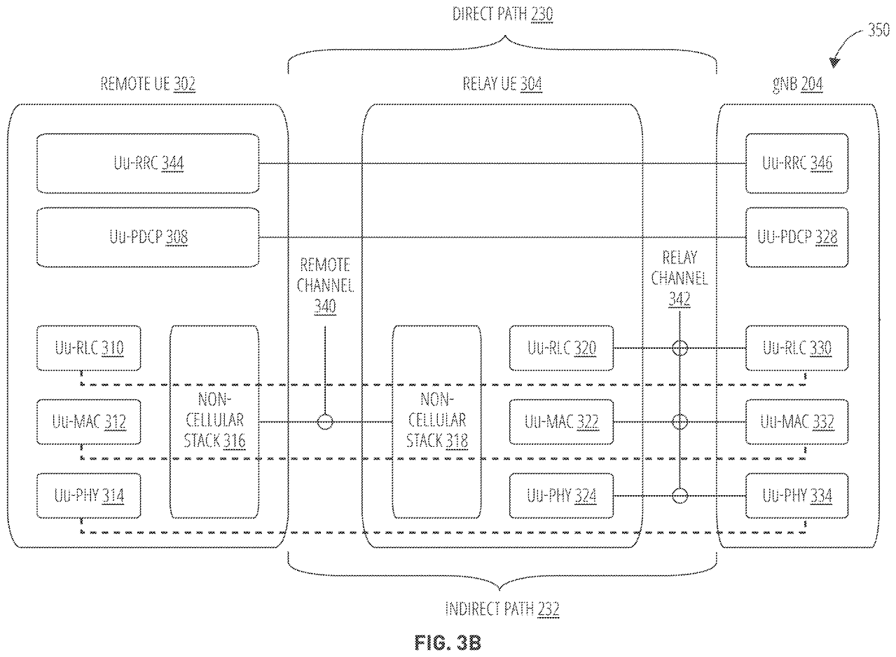

FIG. 3A illustrates a user plane protocol stack 300. The user plane protocol stack 300 is suitable to support communication of information, such as user plane data and/or control plane data, for the wireless communications system 100 and/or the wireless communications system 200. The user plane protocol stack 300 is an example of a protocol stack used for a cellular network, such as a 3GPP network as described with reference to FIG. 1 and FIG. 2, for example. Specifically, the user plane protocol stack 300 is an example of a protocol stack for a multi-path scenario 2 in the multi-path discussion in Rel-18 work and the present disclosure.

As depicted in FIG. 3A, a remote UE 302 and a relay UE 304 may communicate information with a gNB 204, and vice-versa, using the user plane protocol stack 300. For example, the remote UE 302 may comprise an example of the UE 202 and the relay UE 304 may comprise an example of the UE 220. The remote UE 302 may communicate with the gNB 204 via a direct path 230 and/or an indirect path 232. The direct path 230 does not traverse an intermediate device, such as the relay UE 304. The indirect path 232 traverses an intermediate device, such as relay UE 304.

As depicted in FIG. 3A, the user plane protocol stack 300 for 3GPP typically includes multiple layers and associated network interfaces, such as a radio interface like a Uu link, for example. As defined in Rel-17, for example, the user plane protocol stack 300 may comprise a first layer known as a Physical Layer (PHY). This layer is responsible for the physical transmission and reception of data over the air interface. It involves functions such as modulation, coding, and multiplexing of the data. A second layer is a Medium Access Control (MAC) Layer. The MAC layer manages the access to the shared radio resources and provides efficient data transmission between the PHY and higher layers. It handles tasks like scheduling, prioritization, and efficient multiplexing of data. A third layer is a Radio Link Control (RLC) Layer. The RLC layer ensures reliable and efficient transfer of data between the UE and the network. It performs functions such as segmentation, reassembly, error correction, and flow control. A fourth layer is a Packet Data Convergence Protocol (PDCP) Layer. The PDCP layer provides header compression, encryption, and integrity protection for efficient transmission of IP packets over the radio interface. It also handles functions like reordering and duplicate detection of packets. A fifth layer is a Service Data Adaptation Protocol (SDAP) Layer. The SDAP layer classifies, prioritizes, and maps different data flows onto specific radio bearers based on Quality of Service (QOS) requirements. It ensures that different types of traffic receive the appropriate level of service. The user plane protocol stack 300 typically comprises other protocol layers (not shown), such as an Internet Protocol (IP) Layer that handles the routing and addressing of data packets within the network and it performs functions such as encapsulation, decapsulation, and packet routing to ensure end-to-end delivery of data, a Transport Layer that provides reliable and congestion-controlled transport of data between the UE and the network, where it also handles tasks like segmentation, reassembly, flow control, and error recovery, and an Application Layer that represents a highest level of the protocol stack and contains various protocols and services that support specific applications, such as voice, video, messaging, or web browsing.

A network device may implement some or all of the user plane protocol stack 300 depending on its capabilities and operating role in the network. In one embodiment, for example, the remote UE 302 may implement a sub-stack of five protocol layers, including a Uu-SDAP 306, a Uu-PDCP 308, a Uu-RLC 310, a Uu-MAC 312, and a Uu-PHY 314.

Similarly, the gNB 204 may also implement a sub-stack of five protocol layers, including a Uu-SDAP 326, a Uu-PDCP 328, a Uu-RLC 330, a Uu-MAC 332, and a Uu-PHY 334. A relay UE 304 may implement a sub-stack of the user plane protocol stack 300, such as a Uu-RLC 320, a Uu-MAC 322, and a Uu-PHY 324. The remote UE 302, the relay UE 304, and the gNB 204 may communicate information, such as user plane data and/or control plane data, using the user plane protocol stack 300.

The remote UE 302 and the relay UE 304 may also communicate information with each other using a cellular protocol stack, such as the user plane protocol stack 300, as described further below. In this case, the remote UE 302 and the Relay UE 304 may communicate using, for example, the RLC, MAC, and PHY layers of the user plane protocol stack 300.

Additionally, or alternatively, the remote UE 302 and the Relay UE 304 may communicate information with each other using a non-cellular protocol stack. Examples of a non-cellular protocol stack is a D2D protocol stack or a P2P protocol stack for a P2P network. For example, the remote UE 302 may implement a non-cellular stack 316 (e.g., non-3GPP stack) and the relay UE 304 may implement a non-cellular stack 318 (e.g., non-3GPP stack). Although this example uses a non-cellular stack such as a non-3GPP, P2P protocol stack for a P2P network, or a D2D protocol stack, it may be appreciated that any type of cellular or non-cellular protocol stack may be implemented for a communication link between the remote UE 302 and the relay UE 304. Embodiments are not limited to these examples.

In general, a P2P network is a type of network architecture where participants in the network, known as peers, communicate and share resources directly with each other without the need for a central server or intermediary. In a P2P network, every peer has equal capabilities and responsibilities, allowing them to act as both a client and a server. In a traditional client-server network model, a central server manages and controls the network, and clients request resources from the server. However, in a P2P network, each participating node can initiate requests, share resources, and provide services to other nodes in a decentralized manner. P2P networks are often used for file sharing, where peers can directly download files from each other instead of relying on a central file server. Each peer contributes a portion of its own resources, such as processing power, storage, or bandwidth, to facilitate the distribution of data across the network. P2P networks offer several advantages, including increased scalability, fault tolerance, and reduced reliance on a central point of failure. They can efficiently distribute data and services, as well as provide a level of anonymity and privacy. When a network device operates in a P2P mode, the network device may implement any number of shorter-range wired or wireless technologies, as previously described.

A P2P protocol stack may comprise one or more protocol layers for a non-cellular network. For example, a P2P protocol stack may be implemented using an underlying wireless technology such as WiFi technology for a WiFi network (e.g., IEEE 802.11x network). An example of a protocol stack for a WiFi radio may include a PHY layer, a MAC layer, a Distributed Coordination Function (DCF) layer, a Point Coordination Function (PCF) layer, a Logical Link Control (LLC) layer, an IP layer, a Transmission Control Protocol (TCP) layer, a User Datagram Protocol (UDP) layer, and an Application layer.

The remote UE 302 and the gNB 204 may communicate information such as user plane data and/or control plane data via various protocol layers of the user plane protocol stack 300 over the direct path 230. As previously described, the direct path 230 comprise a single communication link 214 between the remote UE 302 and the Relay UE 304. In this case, the remote UE 302 and the gNB 204 do not communicate using the relay UE 304.

The remote UE 302 and the gNB 204 may also communicate information such as user plane data and/or control plane data via various protocol layers of the user plane protocol stack 300 over the indirect path 232. In this case, the indirect path 232 comprises multiple links, such as communication link 222 and communication link 224, for example. The remote UE 302 and the relay UE 304 may communicate information over a remote channel 340 using the non-cellular stack 316 and non-cellular stack 318, respectively, via the communication link 222. For example, the remote channel 340 may comprise a Uu remote UE RLC channel. The relay UE 304 and the gNB 204 may communicate information over a relay channel 342 using layers of the user plane protocol stack 300 via the communication link 224. For example, the relay channel 342 may comprise a Uu relay UE RLC channel. When combined, the remote channel 340 and the relay channel 342 form the indirect path 232.

FIG. 3B illustrates a control plane protocol stack 350. The control plane protocol stack 350 is suitable to support communication of information, such as control plane data and/or user plane data, for the wireless communications system 100 and/or the wireless communications system 200. The control plane protocol stack 350 is an example of a protocol stack used for a cellular network, such as a 3GPP network as described with reference to FIG. 1, for example. Specifically, the control plane protocol stack 350 is an example of a protocol stack for a multi-path scenario 2 in the multi-path discussion in Rel-18 work and the present disclosure.

The control plane protocol stack 350 is similar to the user plane protocol stack 300. However, the control plane protocol stack 350 includes a Uu-RRC 344 layer instead of a Uu-SDAP 306 layer. For the control plane architecture, similar to the case of L2 relay UE 304, the remote UE 302 has a single RRC state based on its RRC connection to its serving gNB 204. If control plane is supported through the indirect path 232 at all (e.g., through a split bearer option), then the control plane protocol stack 350 is shown by FIG. 3B.

For purposes of the present disclosure, an “L2 remote UE” refers to a Layer-2 (L2) source UE, which is registered at the network (e.g., there is Uu UE context at the network) and is in-coverage and in RRC_CONNECTED state to support multi-path and also authorized by the core network 114. Additionally, an “L2 relay UE” refers to an L2 Relay UE supporting UE aggregation and is in-coverage. An L2 relay UE is also assumed to be connected to a network element (e.g., gNB 204) and/or core network 114 when it is performing UE-to-Network data forwarding for the remote UE 302. The relay UE 304 may also be referred to as an “L2 relay UE”, an “L2 forwarding UE”, an “L2 aggregate UE”, and/or the like. Furthermore, a gNB 204 can refer to a RAN node, a Radio Access Network (RAN) and/or NG-RAN.

The present disclosure provides additional details of multi-path enhancements for multi-path scenario 2 beyond what were previously proposed and briefly cover the following issues: (1) procedures of transmit and receive operation for multi-path with a non-3GPP link; and (2) duplication enhancements and failure handling.

As explained previously, the discussion in this disclosure is related to cases where remote UE 302 has connectivity via another UE such as relay UE 304, where the UE-UE inter-connection is assumed to be a theoretical ideal connection. This is referred to as “multi-path scenario 2” for multi-path in RAN2. This could be particularly beneficial to boost the UL data throughput to cater for the limited UL transmission power handicap of any given remote UE 302. Here, the ideal connection could be due to close proximity of the two UEs and/or for example a lossless wired connection between them. Embodiments are not limited in this context.

The procedures for multi-path enabling and transmit and receive operation of multi-path scenario 2 using a UE-UE peer link are described as follows. Multi-path enabling refers to how the remote UE 302 is enabled to utilize the multiple (e.g., two in Rel-18) available paths for packet transfer. For multi-path scenario 2 where the UE-UE peer link is used as the indirect path 232, upon direct path 230 connection establishment, the gNB 204 is informed of the available indirect path 232 and then it provides configuration to the L2 remote UE 302 accordingly. In one example, the configuration for UE aggregation is provided in an RRC reconfiguration within PDCP configuration per bearer or L2remote/relay UE configuration or a new configuration information element (IE), includes an indication which is a BOOLEAN to turn multi-path-ideal-link on or off.

The procedures for DL data transfer are described as follows. In one example, for the receiving operation of L2 relay UE 304, when the indication multi-path-ideal-link for a given remote UE 302 resource bearer (RB) identifier (ID) within, for example, a PDCP-configuration or other configuration, is configured and enabled or set to true, the UE delivers the data packets received on specific configured Uu RLC entities with specific channel IDs, such as from ingress RLC channels that are mapped or configured with corresponding remote UE 302 RB ID to the non-cellular protocol stack such as a P2P stack, for example. In another example, for the receiving operation of L2 U2N remote UE 302 when multi-path-ideal-link for a given remote UE 302 RB ID (within e.g., a PDCP-config or other configuration) is configured and enabled or set to true, the UE delivers the data packets received on the peer link to upper layer (e.g., PDCP) based on the remote UE 302 RB ID through implementation.

The procedures for UL data transfer are described as follows. In one example for the transmitting operation of L2 U2N remote UE 302 when multi-path-ideal-link for a given remote UE 302 RB ID (within e.g., PDCP-config or other configuration) is configured and enabled or set to true and if duplication is enabled/activated for the RB, if it is a PDCP data Protocol Data Unit (PDU), duplicate the data PDU and submit the PDCP PDU to the associated RLC entity (e.g., Uu entity) as per legacy and deliver the packet to the non-cellular protocol stack to be carried to the Relay UE 304 considering that the transmitting PDCP entity is associated with one RLC entity and one peer link.

In another example for the receiving operation of L2 relay UE 304 when multi-path-ideal-link for a given remote UE 302 RB ID (within e.g., PDCP-config or other configuration) is configured and enabled or set to true, the relay UE 304 receives all the packets on the non-cellular link and passes to its own RLC layer/entities based on mapping configuration using remote UE 302 RB ID information received over the non-cellular link.

Each RLC entity, which is established based on gNB configuration, receives the corresponding packets based on one-to-one (1:1) mapping of RLC channel ID associated with the remote UE 302 RB ID depending on the relay UE 304 implementation. Once at the corresponding RLC entity, if the packet is destined for the relay UE 304, it is sent to upper layer.

In another example for the transmitting operation of L2 relay UE 304 when multi-path-ideal-link for a given remote UE 302 RB ID (within e.g., PDCP-config or other configuration) is configured and enabled or set to true, the corresponding Relay UE 304 RLC entity of the egress RLC channel then submits the packet to the lower layer for delivery to the gNB 204.

The CR 0771 to the 3GPP TS 38.300 Standards defines multi-path (MP) relay in Section 16.X titled “Multi-path Relay” that incorporates some of the embodiments disclosed herein, such as the user plane protocol stack 300 and/or the control plane protocol stack 350 described with reference to FIG. 3A and FIG. 3B, respectively. In a multi-path relay scenario, a MP remote UE 302 is connected to a single gNB 204 via one direct path and one indirect path 232 while the MP remote UE 302 is in RRC_CONNECTED state. For the indirect path 232, both L2 and L3 MP Relay architectures are supported. The L3 MP Relay architecture is transparent to the serving NG-RAN of the MP relay UE 304, except for controlling sidelink resources. In the case of MP remote UE 302 using SL indirect path, mode 1 resource allocation is supported only for intra-DU case, with the SR/BSR and grant sent on the direct path 230.

In multi-path relay, the interface between MP remote UE 302 and MP relay UE 304 can be either a Proximity Communication 5 (PC5) interface or a Non-3GPP Connection (NC3) interface. The PC5 and NC3 interfaces are merely examples, and other interfaces may be used as well, such as interfaces suitable for shorter range communications and communication protocols. Embodiments are not limited in this context.

The PC5 interface is a communication interface used for direct device-to-device (D2D) communication in LTE and NR networks. Specifically, the PC5 interface is an interface for a PC5 Relay RLC channel, which is an RLC channel between L2 U2N remote UE 302 and L2 U2N relay UE 304, or between L2 U2U remote UE 302 and L2 U2U relay UE 304, which is used to transport packets over PC5 for L2 UE-to-Network/UE-to-UE Relay. The PC5 interface operates in the unlicensed spectrum to enable direct communication between devices without the need for network infrastructure. It is particularly useful in scenarios where low-latency, high-speed, and reliable communication is required, such as vehicle-to-vehicle (V2V) or vehicle-to-infrastructure (V2I) communication. The PC5 interface allows devices to exchange control and data information directly, enhancing the overall efficiency and performance of the communication network. NC3 is a functional entity that facilitates interworking between the 3GPP network and non-3GPP access networks, such as Wi-Fi or Ethernet.

The N3C interface is a communication interface responsible for managing control plane procedures, including authentication and session establishment, between the 3GPP core network and non-3GPP access network elements. It enables seamless connectivity and interoperability between different types of networks within the 3GPP ecosystem. When the interface between MP remote UE 302 and MP relay UE 304 is a N3C interface, the relationship of MP remote UE 302 and MP relay UE 304 is pre-configured or static, and it is up to a given implementation regarding how to pre-configure or make it static.

Multi-path relay supports MP remote UE 302 and MP relay UE 304 when they are in the intra-gNB, and Primary Cell (PCell) is always on the direct path 230. Multi-path relay is typically supported in the following cell deployment scenarios: (1) the MP relay UE 304 and MP remote UE 302 are served by the same cell; (2) the MP relay UE 304 and MP remote UE 302 are served by different intra-frequency cells of the same gNB; or (3) the MP relay UE 304 and MP remote UE 302 are served by different inter-frequency cells of the same gNB. Multi-path relay is typically supported in the following sidelink scenarios: (1) Sidelink TX/RX and Uu link share the same carrier at the MP remote UE 302; (2) Sidelink TX/RX and Uu link use different carriers at the MP remote UE 302; (3) Sidelink TX/RX and Uu link share the same carrier at the MP relay UE 304; or (4) Sidelink TX/RX and Uu link use different carriers at the MP relay UE 304.

Multi-path relay may utilize a given protocol architecture. For example, from an L2 MP remote UE 302 perspective, three bearer types exist: direct bearer, indirect bearer, and split bearer. For direct bearer, only Uu radio resources are involved, and for indirect bearer, only PC5 or N3C radio resources are involved. For split bearer, both Uu and PC5/N3C radio resources are involved.

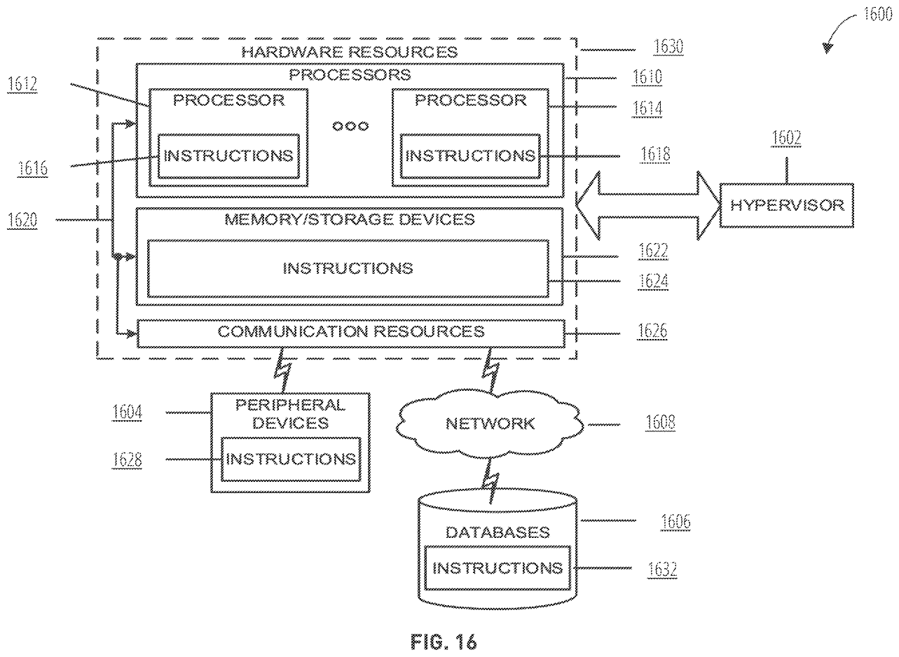

For the multi-path relay using N3C indirect path between the remote UE 302 and relay UE 304, the protocol stacks for the user plane and control plane of L2 MP Relay architecture are illustrated in FIG. 16.x.2.2-1 and FIG. 16.x.2.2-2 of the CR 0771. The L2 MP relay UE 304 and the L2 MP remote UE 302 are connected via a N3C interface.

In the multi-path relay using N3C indirect path 232, the SRAP sublayer does not exist on the protocol stack. Without the SRAP entity between L2 MP remote UE 302 and L2 MP relay UE 304, the Uu SDAP, PDCP, and RRC are terminated at gNB 204 and L2 MP remote UE 302. While RLC, MAC, and PHY are terminated in Uu hop. An UL PDCP PDU in the L2 MP remote UE 302 can be delivered to a Uu RLC entity and an intended PDCP entity or RLC entity in the L2 MP relay UE 304. It is supported for more than one RB over the Uu link of the L 2 MP relay UE 304 by configuring 1:1 bearer mapping between the RB in the L2 MP remote UE 302 and Uu Relay RLC channel in the L2 MP relay UE 304. The Uu Relay RLC channels for the PDU delivery of the L2 MP relay UE 304 local traffic and relay traffic are configured differently. Bearer identification except a Logical Channel Identifier (LCID) is not needed in L2 PDU over the Uu link. If the split bearer is configured and the PDCP PDU duplication is activated on the PDCP entity, the duplicated PDCP PDUs are delivered via both direct path 230 and indirect path 232.

For failure reporting response, similar to dual-connectivity scenario, in a multi-path situation, when a L2 remote UE 302 has multi-path or multi-path-ideal-link enabled or set to true and is currently using direct path 230 and indirect path 232, when one of the links fails, the remote UE 302 could generate and send a path failure report that reports failure information using the other available path. In one example, upon receiving the failure information, the gNB 204 could provide a response with configuration to set the multi-path or multi-path-idea-link to false, thereby changing multi-path to single-path. In another example, the gNB 204 could release the available path and corresponding configuration. In yet another example, the gNB 204 could release the radio configuration associated with the failed path. In yet another example, the gNB 204 could provide configuration to suspend the data transmission and reception for all the radio bearers or specific radio bearers until the failed path is re-established.

The CR 0771 to the 3GPP TS 38.300 Standards defines a path failure report in Section 16.x.3.x titled “Path Failure Report” that incorporates some of the embodiments disclosed herein, such as the failure reporting response discussed herein. Embodiments are not limited to the following examples.

In a first example, the L2 MP remote UE 302 in RRC_CONNECTED performs Uu RLM (as described in clause 9.2.7 of the 3GPP TS 38.300 Standards). When the L2 MP remote UE 302 detects Uu Radio Link Failure (RLF) on the direct path 230, the L2 MP remote UE 302 triggers path failure reporting through the indirect path 232 via an RRC message if split SRB1 is configured and the indirect path 232 is not suspended. Otherwise, RRC connection re-establishment is initiated.

In a second example, when the L2 MP remote UE 302 using PC5 indirect path 232 detects PC5 Radio Link Failure (RLF) and/or Uu link failure on the indirect path 232, the L2 MP remote UE 302 triggers path failure reporting through the direct path 230 via an RRC message if the direct path is not suspended.

In a third example, when the L2 MP remote UE 302 using N3C indirect path 232 detects N3C link failure and/or Uu link failure on the indirect path 232, the L2 MP remote UE 302 triggers path failure reporting through the direct path 230 via an RRC message if the direct path 230 is not suspended.

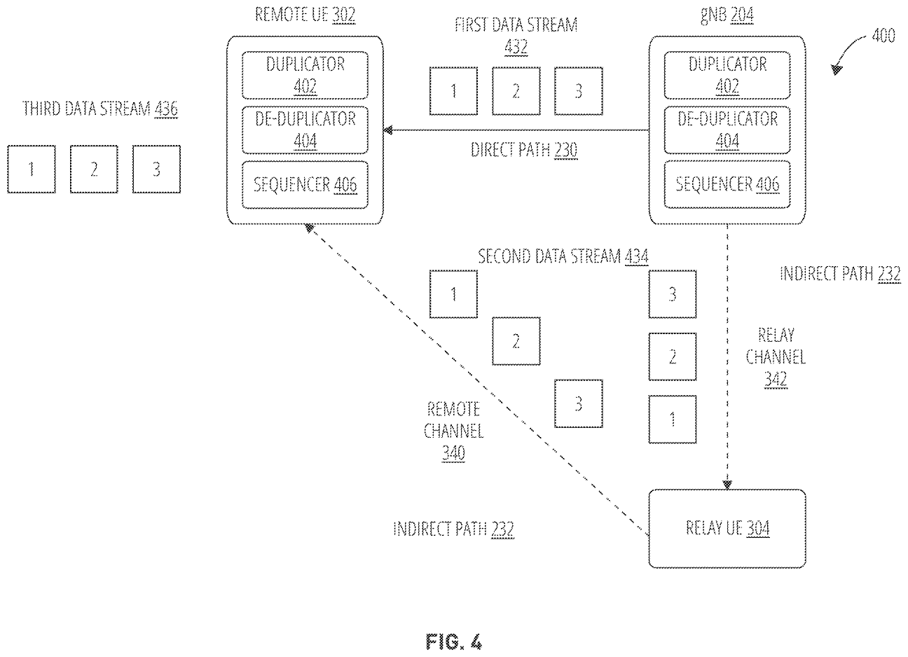

FIG. 4 illustrates an operating environment 400 of the wireless communications system 100 and/or the wireless communications system 200. Specifically, the operating environment 400 provides an example of data duplication and data de-duplication for multi-path relay in a wireless network, such as multi-path scenario 2 of a 3GPP network, for example. In addition, the operating environment 400 provides an example of a sequencer for multi-path relay in a wireless network, such as multi-path scenario 2 of a 3GPP network.

As depicted in FIG. 4, the remote UE 302 and the gNB 204 communicate information with each other in the form of PDUs 1-N, where N represents any positive integer. For example, the gNB 204 may communicate 3 PDUs (i.e., N=3) to the remote UE 302 over the direct path 230 and/or the indirect path 232.

In the operating environment 400, the remote UE 302 or the gNB 204 may operate as a source device or a destination device depending on which device is transmitting a set of information and which device is receiving the set of information. For example, a source device such as the gNB 204 may implement a duplicator 402 to communicate information in a first data stream 432 with a destination device such as the remote UE 302. The gNB 204 transmits the first data stream 432 over the direct path 230. It also uses the duplicator 402 to transmit a duplicate of the set of information in a second data stream 434 over the indirect path 232 via the Relay UE 304. The remote UE 302 may receive the first data stream 432 and/or the duplicate second data stream 434.

When both the direct path 230 and the indirect path 232 are active, the remote UE 302 may receive both the first data stream 432 and the second data stream 434, respectively. In this case, the remote UE 302 uses a de-duplicator 404 to identify and discard duplicate information, such as duplicate data packets (e.g., PDUs), to generate a single unified set of information to output a non-duplicative third data stream 436. The remote UE 302 also uses a sequencer 406 to ensure the data packets (e.g., PDUs) are received in a correct sequential order, such as a stream of PDUs 1, 2, and 3 transmitted in a sequential order from PDU 1 to PDU 3.

The sequencer 406 performs a procedure referred to as “packet reordering.” In data communication networks, packets can sometimes arrive at their destination out of order due to network congestion, routing issues, or varying transmission paths. To ensure the correct sequential delivery of data, the receiving system uses sequence numbers assigned to each packet. During packet reordering, the sequencer 406 examines the sequence numbers of the incoming packets and rearranges them into the correct order. This process involves buffering the out-of-order packets until all the necessary packets are received. Once all the packets are collected, they are reordered based on their sequence numbers, ensuring the data is reconstructed in the intended order and then delivered to the recipient application. By employing sequence numbers, packet reordering helps maintain data integrity and ensures that the original message or data stream transmitted by the sender is faithfully reconstructed at the receiving end.

When the direct path 230 or the indirect path 232 are inactive, the remote UE 302 receives the information as first data stream 432 or the duplicate information as second data stream 434. In this case, the remote UE 302 may skip using the de-duplicator 404. However, the remote UE 302 may still use the sequencer 406 to position the received information in a correct sequential order when the data packets arrive in a receive queue out-of-order.

The above-described processes for the gNB 204 transmitting information to the remote UE 302 using multi-path relay also generally occurs when the source device is the remote UE 302 that communicates information to the gNB 204 as the destination device.

The operating environment 400 illustrates an example of an architecture that supports RAN based redundancy for multi-path scenario 2, that is using multi-path transmission via a direct path 230 over a Uu link and an indirect path 232 through a relay channel 342 and an ideal UE-UE remote channel 340. Increased transmission power is one way of boosting data reliability since it has a direct relation with increasing the Signal to Noise Ratio (SNR). Another way to enhance reliability is data duplication, such as transmitting the same path using multiple communication paths.

In a DL, gNB 204 can duplicate PDUs by implementing the duplicator 402 at the PDCP layer, where it sends two copies, one each over the direct path 230 and indirect path 232 as shown in FIG. 4. The details pertaining to triggering condition, activation/deactivation and so forth of data duplication in downlink can vary based on a given gNB implementation.

In the context of PDCP duplication in Ultra-Reliable Low Latency Communications (URLLC), a t-Reordering timer is configured by the upper layers. However, for the case of sidelink communication, this timer is determined by a given UE implementation. In the case of multi-path transmission in relaying environment, the t-Reordering timer can be configured by upper layers similar to URLLC case and only one t-Reordering timer per receiving PDCP entity is running at a given time. Upon expiry of t-Reordering timer, the receiving PDCP entity (e.g., at the remote UE 302 in the case of DL PDCP duplication) delivers all stored PDCP Service Data Units (SDUs) to the upper layers in ascending order of sequence numbers (SNs). This PDCP duplication in downlink is similar to multi-path scenario 1, where the indirect path 232 is via a PC5 connection with a Relay UE 304. For multi-path scenario 1, sidelink Radio Link Failure (RLF) detection is based on the 3GPP Release 16 (Rel-16) V2X specification while failure detection for peer link is out of 3GPP scope. However, in terms of reordering, if failure occurs (with low probability) over the peer link, the remote UE 302 is unaware of such failure and would wait till expiration of t-reordering timer to receive the missing PDUs, assuming that their duplicated copies are also lost/delayed over Uu, for in sequence delivery to upper layers. For the case of multi-path scenario 2, since data rate and reliability can both be assumed to be high and also deterministic, and there are fewer variables as in the case of a wireless PC5 link in multi-path scenario 1, these factors could impact the length of the t-Reordering timer, however, that is up to a given gNB implementation.

When the indirect path comprises the Relay UE 304, the gNB 204 can perform re-selection if the Relay UE 304 does not meet certain channel quality criteria. On the other hand, in multi-path scenario 2, such re-selection triggers are not considered, therefore having an indication (similar to the case of Relay UE 304) of link failure for the ideal UE-UE connection will be useful. Especially for time sensitive use-cases, the ideal UE could explicitly indicate to the gNB 204 over Uu of a link failure, in which case the gNB 204 can trigger PDCP status report from the remote UE 302. If the gNB 204 has not received acknowledgement for RLC Acknowledge Mode (AM) Uu Data Radio Bearer (DRB) for such packets, it can then retransmit the lost packets as required.

For AM DRBs configured by upper layers to send a PDCP status report in the uplink (statusReportRequired as defined in 3GPP TS 38.331), the receiving PDCP entity triggers a PDCP status report when: (1) upper layer requests a PDCP entity re-establishment; (2) upper layer requests a PDCP data recovery; (3) upper layer requests a uplink data switching; (4) upper layer reconfigures the PDCP entity to release Dual Active Protocol Stack (DAPS) and daps-SourceRelease is configured in 3GPP TS 38.331; and (5) the receiving PDCP entity receives ideal-link failure notification from Relay UE 304 in multi-path scenario 2.

For Unacknowledged Mode (UM) DRBs configured by upper layers to send a PDCP status report in the uplink (statusReportRequired as defined in 3GPP TS 38.331), the receiving PDCP entity triggers a PDCP status report when: (1) upper layer requests an uplink data switching; and (2) the receiving PDCP entity receives ideal-link failure notification from relay UE in multi-path scenario 2.

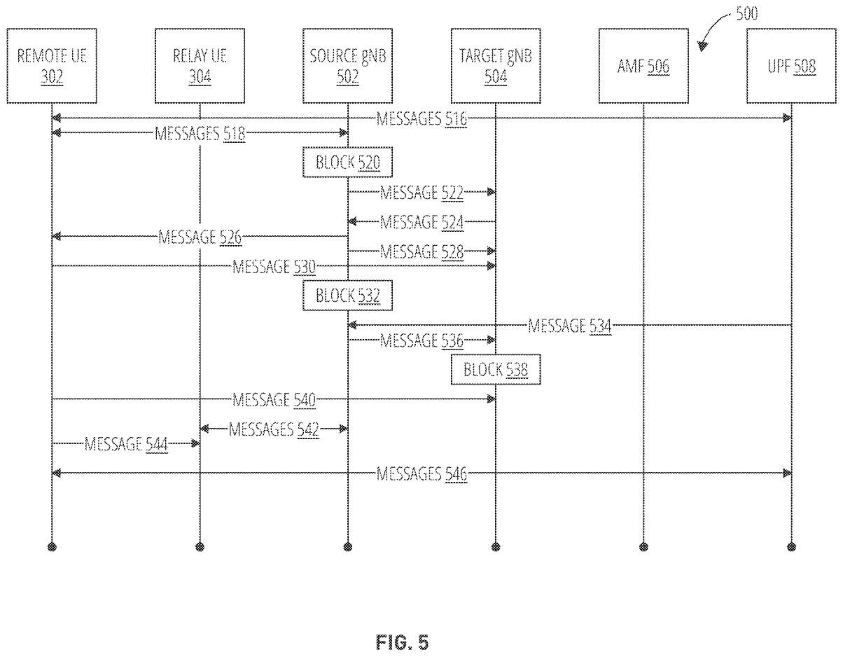

FIG. 5 illustrates a message flow 500. The message flow 500 depicts a message flow between multiple network devices or network entities, such as a remote UE 302, a relay UE 304, a source gNB 502 (or other remote UE 302 and/or other relay UE 304), a target gNB 504 (or other remote UE 302), an AMF 506, and one or more UPF 508. Specifically, the message flow 500 represents an example of a message flow for service continuity and lossless delivery for U2N relaying in accordance with one or more embodiments.

The CR 0771 to the 3GPP TS 38.300 Standards defines a service continuity procedure in Section 16.12.6 titled “Service Continuity for L2U2 N relay.” The service continuity procedure is applicable for the mobility cases of path switch from indirect path 232 to direct path 230 and from direct path 230 to indirect path 232 when the L2 U2N remote UE 302 and L2 U2N relay UE 304 belong to the same gNB or different gNB. This procedure is also applicable for the mobility cases of path switch from indirect path 232 to indirect path 232 when two L2 U2N relay UEs belong to the same gNB or different gNBs. For inter-gNB path switching, the source gNB 502 decides to trigger path switching and the path switch type, i.e., direct path 230 or indirect path 232.

The CR 0771 to the 3GPP TS 38.300 Standards also defines switching from an indirect path 232 to a direct path 230. For service continuity of L2 U2N relay UE 304, in a case of L2 U2N remote UE 302 switching from indirect path 232 to direct path 230 under the same gNB, a procedure is used as depicted in FIG. 16.12.6.1-1 of CR 0771 to the 3GPP TS 38.300 Standards. Specifically, the procedure is for L2U 2 N remote UE 302 intra-gNB switching from indirect path 232 to direct path 230. For service continuity of L2 U2N relay, in case of L2 U2N remote UE 302 switching from indirect path 232 to direct path 230 under another gNB, a procedure is used as depicted in FIG. 16.12.6.1-2 of CR 0771 to the 3GPP TS 38.300 Standards. Specifically, the procedure is for L2U2 N remote UE 302 inter-gNB switching from indirect to direct path.

As depicted in FIG. 5, the message flow 500 illustrates an example of messages and operations for the procedure for L2 U2N remote UE 302 inter-gNB switching from indirect path 232 to direct path 230. Embodiments are not limited to the examples given by the message flow 500.

Message flow 500 begins with the remote UE 302 exchanging messages 516 comprising UL and/or DL data with the UPF 508. The remote UE 302 exchanges messages 518 with the source gNB 502 for measurement configuration and reporting. For example, the Uu measurement configuration is configured by the source gNB 502, and measurement report signalling procedures are performed by the L2 U2N remote UE 302 to evaluate both relay link measurement and Uu link measurement. The measurement results from L2 U2N remote UE 302 are reported when configured measurement reporting criteria are met. The sidelink relay measurement report shall include at least L2 U2N relay UE 304 source L2 ID, serving cell ID (i.e., NCGI/NCI), and sidelink measurement quantity result. The sidelink measurement quantity can be SL-RSRP of the serving L2 U2N Relay UE, and if SL-RSRP is not available, SD-RSRP is used.

At block 520, the source gNB 502 decides to trigger a path switch for the L2 U2N remote UE 302 onto direct path 230. The source gNB 502 sends a message 522 as a HANDOVER REQUEST message to the target gNB 504 with necessary information to prepare the handover at the target side. In order to support the DL lossless handover for the L2 U2N remote UE 302, the source gNB 502 may not discard the DL data even though the delivery of the data has been acknowledged by the L2 U2N relay UE 304 based on the gNB implementation. Then, the source gNB 502 forwards the buffered DL data to the target gNB 504 during the data forwarding procedure.

The target gNB 504 may perform admission control. The target gNB 504 sends a message 524 as a HANDOVER REQUEST ACKNOWLEDGE message to the source gNB 502, which contains new RRC configuration for the L2 U2N remote UE 302. The source gNB 502 triggers the path switch by sending the message 526 as an RRCReconfiguration message to the L2 U2N remote UE 302, containing at least a cell ID and the information required to access the target cell. The L2 U2N remote UE 302 stops User Plane (UP) and Control Plane (CP) transmission via the L2 U2N relay UE after reception of the RRCReconfiguration message.

The source gNB 502 sends a message 528 as a SN STATUS TRANSFER message to the target gNB 504 to convey the uplink PDCP SN receiver status and the downlink PDCP SN transmitter status of the L2 U2N remote UE 302 DRBs for which PDCP status preservation applies (i.e., for RLC AM). The L2 U2N remote UE 302 sends message 530 to synchronize with the target gNB 504 and performs Random Access (RA).

At block 532, the source gNB 502 receives a message 534 with data from the UPF 508, and it delivers buffered data and new data from UPF 508 to the target gNB 504 as message 536. At block 538, the target gNB 504 buffers user data from the relay UE 304 via the source gNB 502.

The L2 U2N remote UE 302 sends a message 540 as an RRCReconfigurationComplete message to target gNB 504 via the direct path 230. The target gNB 504 optionally sends a UE CONTEXT RELEASE message to inform the source gNB 502 about the success of the path switch.

The source gNB 502 and relay UE 304 exchange messages 542 for RRC reconfiguration and RRC reconfiguration complete, such as an RRCReconfiguration message to the L2 U2N relay UE 304 to reconfigure the connection between the L2 U2N relay UE 304 and the source gNB 502. The RRCReconfiguration message to the L2 U2N relay UE 304 can be sent any time after SN STATUS TRANSFER based on a given source gNB 502 implementation. For example, the RRCReconfiguration message may include values carried by one or more IEs to release Uu Relay RLC channel and PC5 Relay RLC channel configuration for relaying, and bearer mapping configuration related to the L2 U2N Remote UE, among other RRC reconfiguration information. Either L2 U2N relay UE 304 or L2 U2N remote UE 302 AS layer indicates upper layer to release PC5 unicast link after receiving the RRCReconfiguration message from the source gNB 502. The timing to execute link release is up to a given UE implementation. For example, the remote UE 302 may send a message 544 as a PC5 link release message to the relay UE 304.

Once HO is complete, the remote UE 302 and the UPF 508 may exchange messages 546 with UL and/or DL data via the target gNB 504.

As described above, the message flow 500 illustrates an example of messages and operations for the procedure for L2 U2N remote UE 302 inter-gNB switching from indirect path 232 to direct path 230. Path switching from an indirect path 232 to direct path 230 is supported for U2N L2 relay based, at least in part, on legacy 3GPP Release 15 (Rel-15) handover (HO) operations, such that the remote UE 302 stops User Plane (UP) and Control Plane (CP) transmission via the L2 relay UE 304 after reception of an RRCReconfiguration message with the path switch configuration. An example of this path switching procedure for the indirect path 232 to direct path 230 inter-gNB scenario is shown in the message flow 500. The message flow 500 is based, at least in part, on the 3 GPP Rel-17 Relay UE 304 intra-gNB indirect path 232 to direct path 230 switching case. For the intra-gNB scenario in 3GPP Rel-17, the PDCP re-establishment or PDCP data recovery in uplink is performed by the L2 remote UE 302 for lossless delivery during path switch if the gNB configures it as defined in 3GPP TS 38.300, for example.

The message flow 500 provides examples of inter-gNB U2N relaying for both uplink (UL) and downlink (DL) use-cases, where data loss could occur, such as when following the 3GPP Rel-15 legacy break-before-make handover policy.

In one example, for the DL scenario, relay UE 304 receives and acknowledges delivery of PDUs on RLC AM bearer from the source gNB 502. The source gNB 502 decides to perform path switching to direct path 230 following measurement event X1 and it sends an RRCReconfiguration message to remote UE 302, upon which remote UE 302 stops UP and CP transmission via the L2 U2N relay UE 304. During this time, if a PC5 RLF occurs, data loss could occur. This is because the RLC is terminated at each hop. The source gNB 502 may have received acknowledgement from lower layers for certain packets successfully received by the relay UE 304. However, upon PDCP re-establishment the remote UE 302 is not aware of these packets and they are consequently lost.

In another example, for the UL scenario, relay UE 304 receives and acknowledges delivery of PDUs on SL-RLC AM bearer from the remote UE 302. The source gNB 502 decides to perform path switching to direct path following measurement event X1 and sends an RRCReconfiguration message to remote UE 302, upon which remote UE 302 stops UP and CP transmission via the L2 U2N relay UE 304. If Uu RLF occurs after remote UE 302 stops UP/CP transfer using relay UE 304, the relay UE 304 cannot indicate to the remote UE 302 of the Uu RLF, and data loss could occur. This is because the remote UE 302 may have received acknowledgement from lower layers for certain packets successfully received by the relay UE 304. However, they may not have been received by the source gNB 502 and therefore not included in the SN STATUS transfer to be recovered.

Even though the PDCP is terminated between the remote UE 302 and the gNB, and does not have per-hop termination as in the case of RLC layer, for PDCP data recovery (if performed by the remote UE 302 per gNB configuration as in the case of intra-gNB path switching), the following condition needs to be met as given in 3GPP TS 38.232, for example. For AM DRBs, when upper layers request a PDCP data recovery for a radio bearer, the transmitting PDCP entity performs retransmission of all the PDCP Data PDUs previously submitted to re-established or released AM RLC entities in ascending order of the associated COUNT values for which the successful delivery has not been confirmed by lower layers.

Similarly a procedure for the case of PDCP entity re-establishment is performed as follows: (1) for SRBs, discard all stored PDCP SDUs and PDCP PDUs; (2) apply the ciphering algorithm and key provided by upper layers during the PDCP entity re-establishment procedure; (3) apply the integrity protection algorithm and key provided by upper layers during the PDCP entity re-establishment procedure; (4) for UM DRBs, for each PDCP SDU already associated with a PDCP SN but for which a corresponding PDU has not previously been submitted to lower layers, and; (5) for AM DRBs for Uu interface whose PDCP entities were suspended, from the first PDCP SDU for which the successful delivery of the corresponding PDCP Data PDU has not been confirmed by lower layers, for each PDCP SDU already associated with a PDCP SN: (5.1) consider the PDCP SDUs as received from upper layer; (5.2) perform transmission of the PDCP SDUs in ascending order of the COUNT value associated to the PDCP SDU prior to the PDCP re-establishment without restarting the discardTimer, as specified in clause 5.2.1 of TS 38.323; (5.3) for AM DRBs whose PDCP entities were not suspended, from the first PDCP SDU for which the successful delivery of the corresponding PDCP Data PDU has not been confirmed by lower layers, perform retransmission or transmission of all the PDCP SDUs already associated with PDCP SNs in ascending order of the COUNT values associated to the PDCP SDU prior to the PDCP entity re-establishment (other <text omitted>).

As mentioned in both the UL and DL scenarios, in the case of RLF, there is the possibility of confirmation of successful delivery by the lower (RLC) layer and end-to-end lossless transmission is not guaranteed. This issue was raised for the case of intra-gNB transfer. However, considering as a corner case, no specification change was agreed upon. However, for the case of inter-gNB path switching, where path switching may be slower as compared to intra-gNB path switching, the probability of an RLF (Uu or PC5) to occur is higher, and therefore some technique to ensure lossless delivery (possibly with minimum specification impact) could be pursued.

A procedure for updated status reporting is performed as follows. The relay UE 304 is made aware of the path switch command sent from the gNB to the remote UE 302. This could be via a PC5-RRC message from the remote UE 302, or signaling from the source gNB 502. In this case, when the relay UE 304 receives the path switch indication for the remote UE 302, it indicates to the remote UE 302 via PC5 or to the gNB via Uu link, of all data in UL/DL which has not been forwarded to the next hop. This could be similar to a Status PDU (e.g., using RLC SNs since PDCP SNs are not known to the relay UE 304) to the remote UE 302 for DL or to the source gNB 502 for uplink. That is, e.g. for the case of DL, the relay UE 304 informs the remote UE 302 of all buffered data not yet acknowledged by lower layers for the PC5 hop, and the remote UE 302 includes in the PDCP status report SNs for the PDUs indicated by the relay UE 304.

Upon receiving the path switch command, the remote UE 302 sends a PDCP status report to the source gNB 502, before the source gNB 502 performs SN status transfer to the target gNB 504, that is, the path switching triggers a PDCP status report.

A procedure for data buffering is performed as follows. The relay UE 304 retains both UL and DL data, until PDCP retransmission/reestablishment is complete.

For UL data transfer, the relay UE 304 buffers the UL data not RLC acknowledged over Uu. In the case of Uu RLF, the relay UE 304 sends a PC5 -S or PC5 -RRC message to the remote UE 302 with information on the buffered data not yet acknowledged by the source gNB 502.

During PDCP re-establishment, or data recovery, if the remote UE 302 in the case of DL, or the source gNB 502 in the case of UL detect data loss, the relay UE 304 may forward the buffered data or maintained information to the remote UE 302 or source gNB 502 respectively, as needed. To this end, a path switch buffering timer, pathSwitchBufferTimer, may be needed to determine for how long the packets need to be buffered. Since the PDCP entity is not located at the relay UE 304, existing SDU discard mechanisms based on the discardTimer cannot be adopted by the relay UE 304 in this case, and a new timer needs to be defined. Another point to consider in this case of data buffering would be the capability of the relay UE 304 to support storing remote UE 302 data. This is because since the relay UE 304 is another UE, it could have limitations on its power consumption and memory/storage. If a relay UE 304 is capable of supporting data buffering, the gNB may configure it to support lossless delivery only during path switch and not otherwise. Another possible limitation for the case of UE to network relaying is that if the relay UE 304 moves away from the remote UE 302 during path switching procedure, such that it is no longer in coverage of both source gNB 502 and target gNB 504, it has to discard the buffered data. This could potentially use the same pathSwitchBufferTimer.

In 3GPP Rel- 17 , the timing of PC 5 link release is up to UE implementation and it can be performed by either L2 U2N relay UE 304 or L2 U2N remote UE 302 AS layer. For the case of inter-gNB path switching from indirect path 232 to direct path 230, it can be mandated that the PC5 link is maintained until PDCP data recovery process is complete.

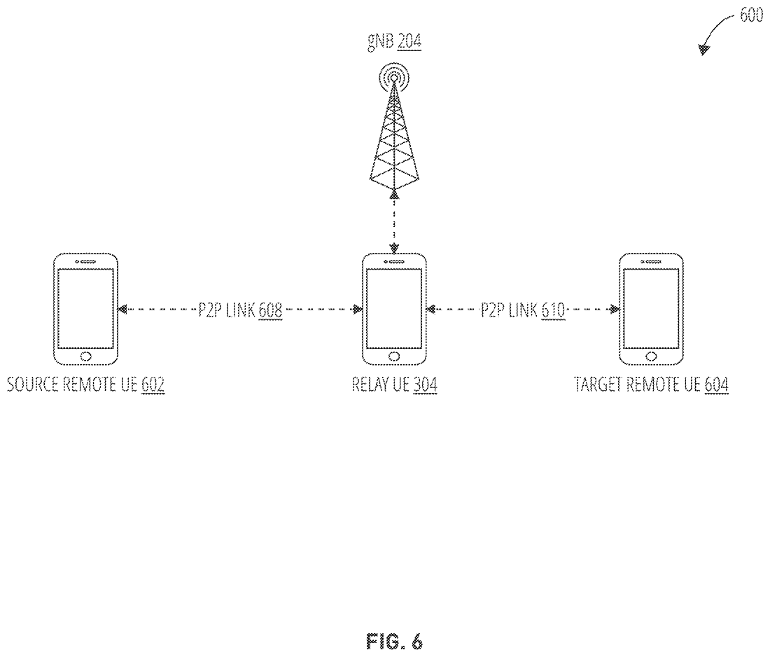

FIG. 6 illustrates a wireless communications system 600. The wireless communications system 600 is similar to the wireless communications system 100 and the wireless communications system 200. The wireless communications system 600 provides an example of sidelink U2U relaying service continuity support. Specifically, for better support of the use cases for sidelink relay, support of UE-to-UE relay is useful for sidelink coverage extension without relying on the use of uplink and downlink. This is specified in 3GPP Rel-18.

FIG. 6 shows another example scenario of UE-to-UE relaying where there is PC5 link established between a source remote UE 602 and a relay UE 304, and the relay UE 304 and a target remote UE 604, in order to establish an end-to-end PC5 link between the source remote UE 602 and the target remote UE 604 or another destination UE via the relay UE 304. The relay UE 304 may communicate with the gNB 204, thereby allowing a communication path from the source remote UE 602 to the gNB 204 via the relay UE 304, as well as from the target remote UE 604 to the gNB 204 via the relay UE 304. Embodiments are not limited to this topology.

Each of the PC5 links needs to be maintained separately to ensure that the source remote UE 602 can communicate successfully to the destination UE or target remote UE 604. In one example, in Layer-2 UE-to-UE relaying with sidelink, when the PC5 link between the target remote UE 604 or destination UE and the UE-to-UE relay fails, the relay UE 304 may provide a notification message with an indication of PC5link2 failure notification to enable the source remote UE 602 to quickly perform any of relay re-selection or buffering the data, releasing the PC5 connection, or informing the upper layer to determine what any of the actions to be taken for service continuity and reliability.

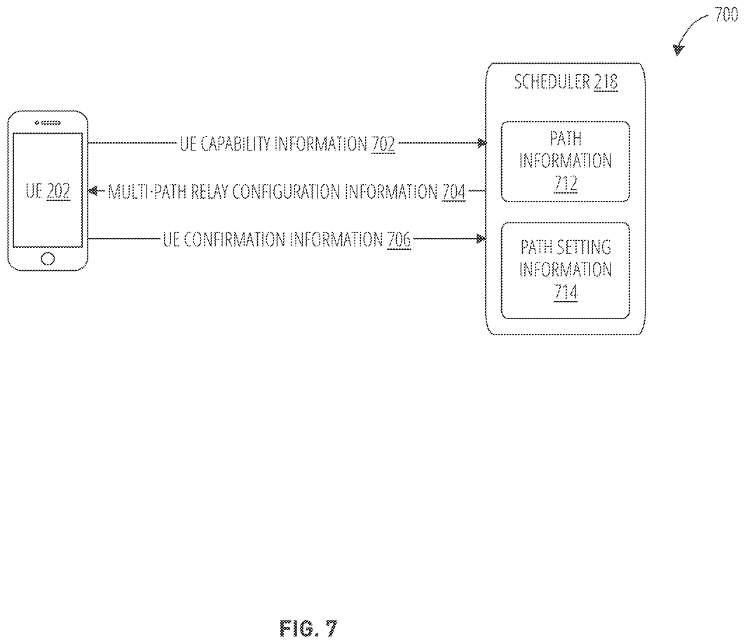

FIG. 7 illustrates an operating environment 700. The operating environment 700 illustrates operations for the wireless communications system 100, the wireless communications system 200, and/or the wireless communications system 600.

As depicted in FIG. 7, the UE 202 is in communication with a scheduler 218 for one or more RAN nodes, such as gNB 204, for example. The UE 202 may be implemented as a remote UE 302 or a relay UE 304. The UE 202 may communicate with the scheduler 218 to coordinate multi-path relay operations for the UE 202. The UE 202 may send UE capability information 702 to the scheduler 218. The scheduler 218 may receive the UE capability information 702, and generate multi-path relay configuration information 704 for the UE 202. The scheduler 218 may send the multi-path relay configuration information 704 to the UE 202. The UE 202 may configure its multi-path relay operations in accordance with the multi-path relay configuration information 704. The UE 202 may send the UE confirmation information 706 to the scheduler 218. The scheduler 218 may then update network settings and send new control directives to the UE 202 based on the UE confirmation information 706.

During RRC connection setup, the UE 202 sends an RRC Connection Request message to the gNB 204. The RRC Connection Request includes information such as a UE identity and establishment cause (e.g., mo-data, mo-signalling, etc.). Upon receiving the RRC Connection Request message and after processing it, the gNB 204 sends an RRC Connection Setup message to the UE 202. This message carries the initial configuration for the UE 202, including a Signalling Radio Bearer 1 (SRB1) configuration and other parameters necessary for the UE 202 to communicate in RRC Connected mode. SRB1 is used for transmitting RRC and Non-Access Stratum (NAS) messages. Once the UE 202 receives and processes the RRC Connection Setup message, it moves to the RRC Connected state and responds with an RRC Connection Setup Complete message. This message usually carries the selected public land mobile network identifier (PLMN-ID) and initial NAS message, which typically includes the Service Request message or Attach Request message to initiate NAS level procedures for network attachment and service accessibility. The RRC Connection Setup process results in the establishment of SRB1, allowing the UE 202 and gNB 204 to exchange RRC and NAS messages. The UE moves from RRC Idle state to RRC Connected state, enabling it to initiate the NAS procedures to access network services. The initial configurations provided in the RRC Connection Setup message will enable the UE 202 to communicate with the network in the RRC Connected state effectively.

Sometime during or after RRC connection setup, the UE 202 sends UE capability information 702 to the gNB 204. The UE capability information 702 may include path information 712, path setting information 714, or a combination of path information 712 and path setting information 714.

The UE capability information 702 includes path information 712 about UE capabilities, including whether the UE 202 is a remote UE 302 capable of communicating with a relay UE 304, or vice-versa. The path information 712 may comprise information describing communication capabilities of the UE 202, including whether the UE 202 has a non-cellular protocol stack that is suitable for establishing a remote channel 340 with a relay UE 304 when the UE 202 is configured as a remote UE 302, a remote channel 340 with a remote UE 302 when the UE 202 is configured as a relay UE 304, or a relay channel 342 with the gNB 204 when the UE 202 is configured as a relay UE 304. For example, the UE 202 may be equipped with multiple radio-frequency (RF) transceivers capable of operating in accordance with longer-range cellular protocols and/or shorter-range non-cellular protocols.

The UE capability information 702 also includes path setting information 714. The path setting information 714 includes information related to multi-path relay capabilities for the UE 202. Examples of path setting information 714 includes without limitation whether multi-path relay is enabled or disabled, handover (HO) procedures for sustainability of indirect path 232 user plane data or control plane data, RLC failure report procedures, radio bearer (RB) information, ingress Uu RLC channels, egress Uu RLC channels, t-reordering timer information, PDCP status report information, path switching information, SN status transfer information, data buffering information, relay selection information, relay re-selection information, or any type of path related information related to multi-path relay.

The UE 202 may send the UE confirmation information 706 to the scheduler 218. The UE confirmation information 706 may include acknowledgement or non-acknowledgement of the multi-path relay configuration information 704 from the scheduler 218, a request for new path information 712, a request for new path setting information 714, and any type of confirmation information related to multi-path relay.

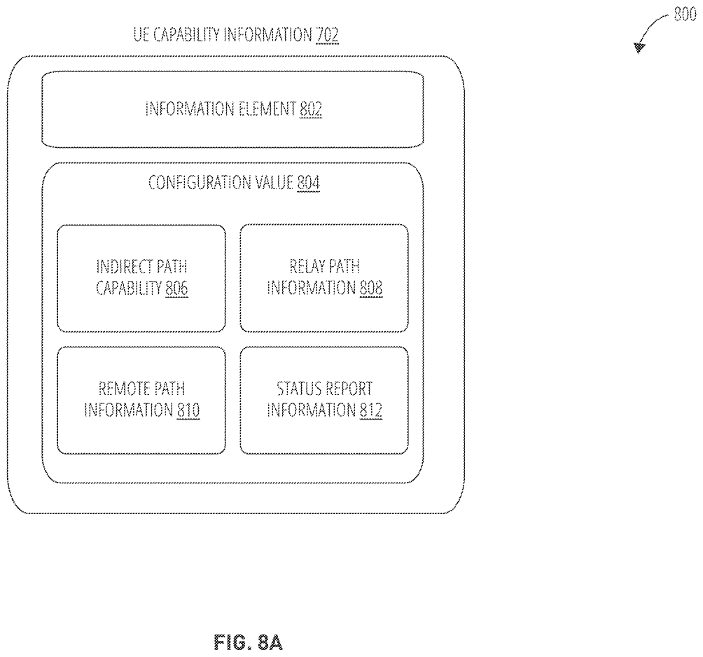

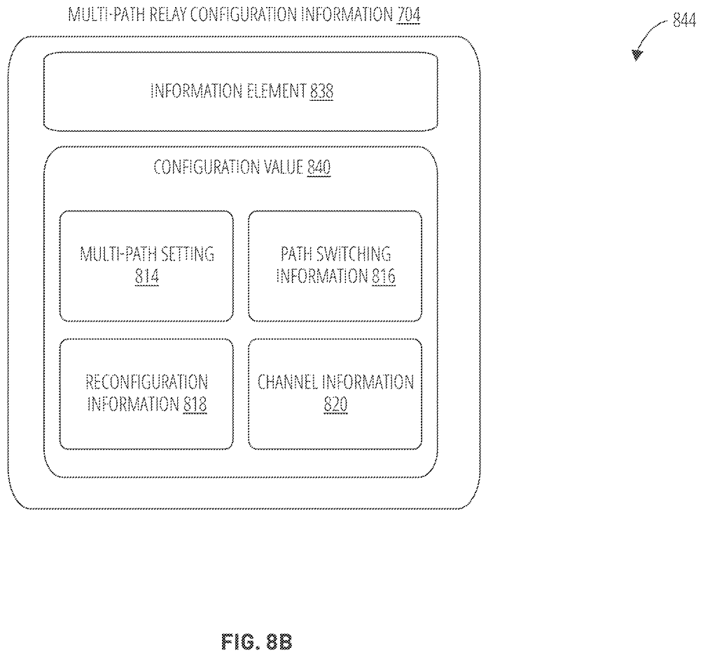

FIG. 8A illustrates a more detailed view of a data schema 800 or messaging format suitable for communicating the UE capability information 702. As depicted in FIG. 8A, the UE 202 may communicate UE capability information 702 including path information 712 and/or the path setting information 714 in messages defined in accordance with one or more 3GPP standards, such as 3GPP TS 38.300 Standards, for example.

The UE capability information 702 may be carried by a network message comprising an information element 802. Examples of network messages and/or information element 802 may include without limitation any network messages, such as 3GPP Release 17 or Release 18 defined messages and/or information elements. Examples of configuration value 804 may include without limitation indirect path capability 806, relay path information 808, a remote path information 810, and status report information 812. Each of the indirect path capability 806, relay path information 808, remote path information 810 and status report information 812 may comply with corresponding values defined in 3GPP 38.300 Standards. Embodiments are not limited to these examples.

FIG. 8B illustrates a more detailed view of a data schema 844 or messaging format suitable for communicating the multi-path relay configuration information 704. As depicted in FIG. 8B, the base station, such as the gNB 204, may communicate multi-path relay configuration information 704 including path information 712 and/or the path setting information 714 in messages defined in accordance with one or more 3GPP standards, such as 3GPP TS 38.300 Standards, for example.

The multi-path relay configuration information 704 may be carried by a network message comprising an information element 838. Examples of network messages and/or information element 838 may include without limitation any network messages, such as 3GPP Release 17 or Release 18 defined messages and/or information elements. Examples of configuration value 840 may include without limitation multi-path setting 814, path switching information 816, reconfiguration information 818, and channel information 820. Each of the multi-path setting 814, path switching information 816, reconfiguration information 818, and channel information 820 may comply with corresponding values defined in 3 GPP 38.300 Standards. Embodiments are not limited to these examples.

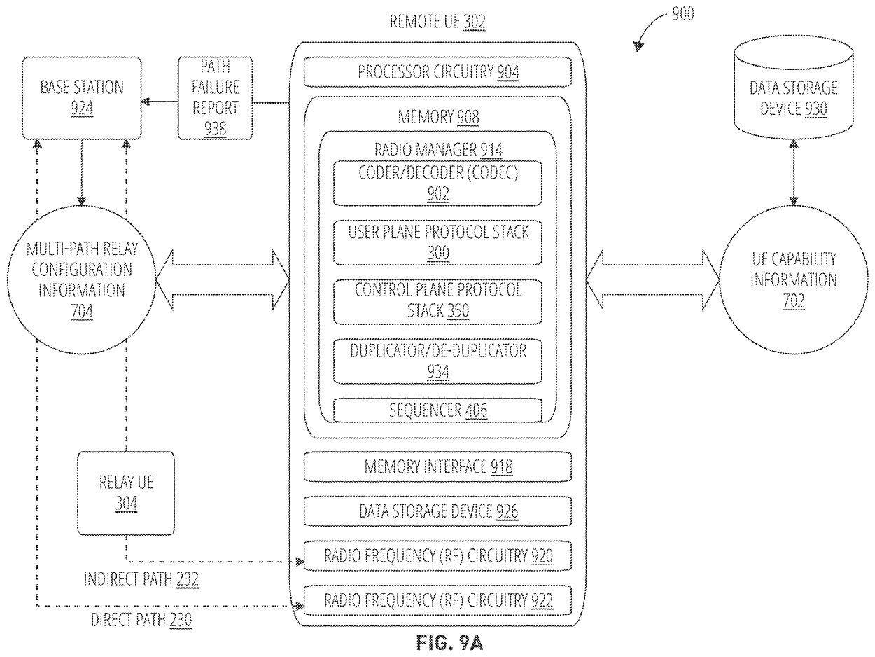

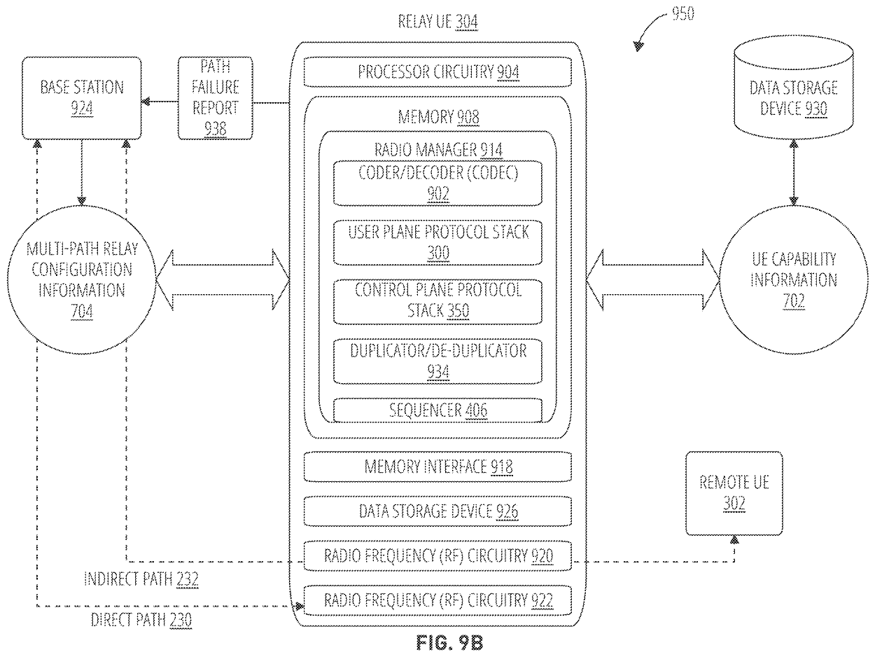

FIG. 9A illustrates an apparatus 900 suitable for implementation as a UE 202 in the wireless communications system 100. As previously discussed, the UE 202 may operate as a remote UE 302 or a relay UE 304 as defined by the 3GPP TS 38.300 Standards, including CR 0771, or other 3GPP standards or non-3GPP standards. In FIG. 9A, the UE 202 is configured to operate as a remote UE 302. Embodiments are not limited in this context.

As depicted in FIG. 9A, the apparatus 900 may comprise a processor circuitry 904, a memory 908 with a radio manager 914, a memory interface 918, a data storage device 926, and RF circuitry 920, and RF circuitry 922. The radio manager 914 may comprise a codec 902, a user plane protocol stack 300, a control plane protocol stack 350, a duplicator/de-duplicator 934 (e.g., a combination of the duplicator 402 and the de-duplicator 404), and the sequencer 406. The RF circuitry 920 may comprise RF circuitry for an indirect path 232. For example, the RF circuitry 920 may utilize one or more shorter-range communication protocols, such as non-cellular protocols like WiFi or Bluetooth, among others. The RF circuitry 922 may comprise RF circuitry for a direct path 230. For example, the RF circuitry 922 may utilize one or more longer-range communication protocols, such as cellular protocols like 3GPP 5G, NR, or 6G, among others. The apparatus 900 may optionally include a set of platform components (not shown) suitable for a UE 202, such as input/output devices, memory controllers, different memory types, network interfaces, hardware ports, and so forth.

The apparatus 900 for the UE 202 may receive multi-path relay configuration information 704 from a base station 924 via the RF circuitry 920. The base station 924 may comprise a NodeB, an eNodeB, or gNB 204 of the wireless communications system 100, the wireless communications system 200, and/or the wireless communications system 600. The apparatus 900 may decode multi-path relay configuration information 928 from the UE confirmation information 706 as previously described.

In one example, the apparatus 900 for UE 202, includes a memory interface 918 to send or receive, to or from a data storage device 930, multi-path relay configuration information 704 for a wireless communications system 100, a wireless communications system 200, or a wireless communications system 600. The apparatus 900 also includes processor circuitry 904 operably coupled to the memory interface 918. The processor circuitry 904 is arranged to determine whether multi-path relay is enabled based on the multi-path relay configuration information 928. The processor circuitry 904 encodes a first data stream 432 of packet data units (PDUs) for uplink (UL) data transfer over a direct path 230 to a base station 924. The processor circuitry 904 encodes a second data stream 434 of PDUs for UL data transfer over an indirect path 232 to the base station 924. The second data stream 434 of PDUs is a duplicate of the first data stream 432 of PDUs. The indirect path 232 may comprise a remote channel 340 and a relay channel 342.

The processor circuitry 904 may forward the encoded first data stream 432 of PDUs to a cellular protocol stack for UL data transfer over the direct path 230 to the base station 924. The processor circuitry may forward the encoded second data stream 434 of PDUs to a non-cellular protocol stack, such as 3GPP user plane protocol stack 300 or 3GPP control plane protocol stack 350, for UL data transfer over the remote channel 340 of the indirect path 232 to a relay UE 304. The direct path 230 may traverse a single communication link 214 and the indirect path 232 may traverse multiple communication links, such as communication link 222 and communication link 224. The remote channel 340 may comprise a non-cellular channel, such as remote channel 340, using a non-cellular protocol stack, such as non-cellular stack 316. The relay channel 342 may comprise a cellular channel using a cellular protocol stack.

The remote channel 340 may comprise a communication channel between a remote UE 302 and a relay UE 304. The relay channel 342 is a communication channel between the relay UE 304 and the base station 924.

The processor circuitry 904 may decode a third data stream of packet data units (PDUs) for downlink (DL) data transfer over the direct path 230 from the base station 924. The processor circuitry 904 may decode a fourth data stream of PDUs for DL data transfer over the remote channel 340 of the indirect path 232 from the base station 924. The fourth data stream of PDUs is a duplicate of the third data stream of PDUs. The processor circuitry 904 may generate a fifth data stream from the third data stream of PDUs and the fourth data stream of PDUs.

The processor circuitry 904 may detect radio link failure (RLF) on the direct path 230 or the indirect path 232. The processor circuitry 904 may generate a path failure report 938 to indicate the RLF of the direct path 230 or the indirect path 232, and encode the path failure report 938 for UL data transfer over the direct path 230 to the base station 924 when the RLF is for the indirect path 232, or encode the path failure report 938 for UL data transfer over the indirect path 232 to the base station 924 when the RLF is for the direct path 230.

As previously discussed, the remote UE 302 may perform multi-path relay operations and actions based on one or more multi-path relay configurations as defined by the 3GPP TS 38.300 Standards, the CR 0771 to the 3GPP TS 38.300 Standards, or other 3GPP standards or non-3GPP standards. Embodiments are not limited in this context.

FIG. 9B illustrates an apparatus 950 suitable for implementation as a UE 202 in the wireless communications system 100. As previously discussed, the UE 202 may operate as a remote UE 302 or a relay UE 304 as defined by the 3GPP TS 38.300 Standards, including CR 0771, or other 3GPP standards or non-3GPP standards. In FIG. 9B, the UE 202 is configured to operate as a relay UE 304. Embodiments are not limited in this context.

The relay UE 304 is similar to configuration as the remote UE 302. However, the multi-path relay configuration information 928 further includes other types of information, such as mapping information (e.g., RLC information, RB information, ingress channel information, egress channel information, etc.) to allow the relay UE 304 to recognize and forward data streams with PDUs that are received from the base station 924 and that are intended for the remote UE 302, as previously described.

In one example, the apparatus 950 for a relay UE 304 includes a memory interface 918 to send or receive, to or from a data storage device 930, multi-path relay configuration information 704 for a wireless communications system 100, wireless communications system 200, or wireless communications system 600. The apparatus 950 also includes processor circuitry 904 operably coupled to the memory interface 918, the processor circuitry 904 to decode a data stream of PDUs for UL data transfer from a remote channel 340 of an indirect path 232 for a remote UE 302, and encode the data stream of PDUs for UL data transfer over a relay channel 342 of the indirect path 232 to a base station 924 for the remote UE 302. The processor circuitry 904 may decode a data stream of PDUs for downlink (DL) data transfer from a relay channel 342 of an indirect path 232 for a base station 924, and encode the data stream of PDUs for DL data transfer over a remote channel 340 of the indirect path 232 to a remote UE 302 for the base station 924.

As previously discussed, the relay UE 304 may perform multi-path relay operations and actions based on one or more multi-path relay configurations as defined by the 3GPP TS 38.300 Standards, the CR 0771 to the 3GPP TS 38.300 Standards, or other 3GPP standards or non-3GPP standards. Embodiments are not limited in this context.

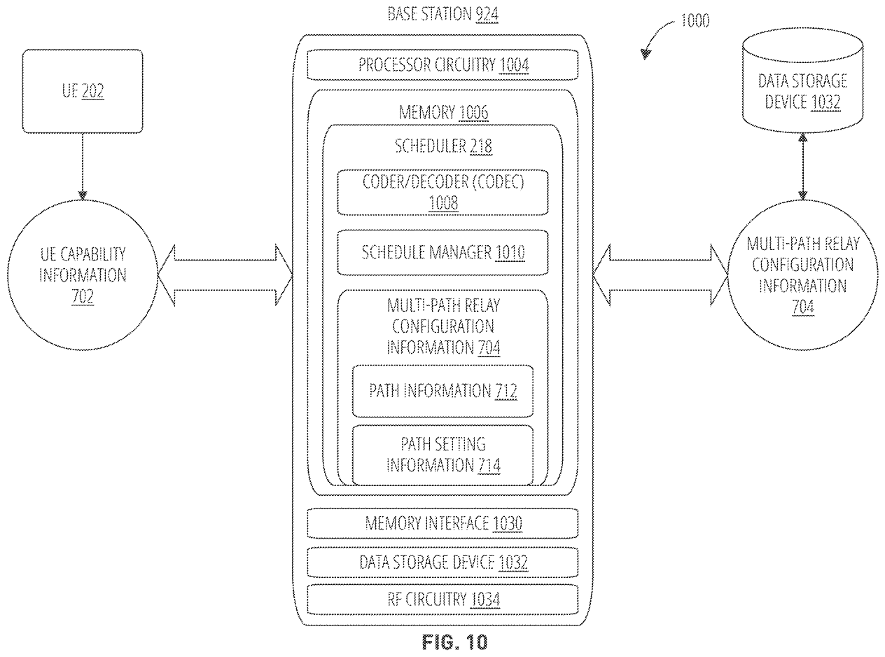

FIG. 10 illustrates an apparatus 1000 suitable for implementation as a base station 924 in the wireless communications system 100, the wireless communications system 200, and/or the wireless communications system 600. The base station 924 is an example of the gNB 204. As previously discussed, the base station 924 may receive UE capability information 702 from the UE 202. The base station 924 may send multi-path relay configuration information 704 to the UE 202 based on the received UE capability information 702. The UE 202 may be arranged to operate as a remote UE 302 or a relay UE 304.

As depicted in FIG. 10, the apparatus 1000 may comprise a processor circuitry 1004, a memory 1006 with a scheduler 218, a memory interface 1030, a data storage device 1032, and RF circuitry 1034. The scheduler 218 may comprise a codec 1008 and a schedule manager 1010. The scheduler 218 may generate the multi-path relay configuration information 704, including the path information 712 and the path setting information 714.

The apparatus 1000 may optionally include a set of platform components (not shown) suitable for a UE 202, such as input/output devices, memory controllers, different memory types, network interfaces, hardware ports, and so forth.

In one embodiment, the apparatus 1000 may be implemented for the base station 924. For example, the apparatus 1000 for a base station 924, includes a memory interface 1030 to send or receive, to or from a data storage device 1032, multi-path relay configuration information 704 for a wireless communications system 100, wireless communications system 200, and/or wireless communications system 600. The apparatus 1000 also includes processor circuitry 1004 operably coupled to the memory interface 1030, the processor circuitry 1004 to encode a first data stream 432 of packet data units (PDUs) for downlink (DL) data transfer over a direct path to a remote UE 302, forward the encoded first data stream 432 of PDUs to a cellular protocol stack for the DL data transfer over the direct path 230 to the remote UE 302, encode a second data stream 434 of PDUs for DL data transfer over an indirect path 232 to the remote UE 302, wherein the second data stream 434 of PDUs is a duplicate of the first data stream 432 of PDUs, and forward the encoded second data stream 434 of PDUs to the cellular protocol stack for DL data transfer over a relay channel 342 of the indirect path 232 to a relay UE 304.

The processor circuitry 1004 may decode a third data stream of PDUs for uplink (UL) data transfer over the direct path 230 from the remote UE 302, decode a fourth data stream of PDUs for UL data transfer over the relay channel 342 of the indirect path 232 from a relay UE 304 on behalf of the remote UE 302, where the fourth data stream of PDUs is a duplicate of the third data stream of PDUs, and generate a fifth data stream from the third data stream of PDUs and the fourth data stream of PDUs. The processor circuitry 904 may remove duplicate PDUs from the third data stream and the fourth data stream to generate the fifth data stream. The processor circuitry 1004 may perform packet reordering to reorder PDUs from the third data stream or the fourth data stream according to a sequence number for each PDU to generate the fifth data stream in a sequential order.

As previously discussed, the base station 924 may perform multi-path relay operations and actions based on one or more multi-path relay configurations as defined by the 3GPP TS 38.300 Standards, the CR 0771 to the 3GPP TS 38.300 Standards, or other 3GPP standards or non-3GPP standards. Embodiments are not limited in this context.

Operations for the disclosed embodiments may be further described with reference to the following figures. Some of the figures may include a logic flow. Although such figures presented herein may include a particular logic flow, it can be appreciated that the logic flow merely provides an example of how the general functionality as described herein can be implemented. Further, a given logic flow does not necessarily have to be executed in the order presented unless otherwise indicated. Moreover, not all acts illustrated in a logic flow may be required in some embodiments. In addition, the given logic flow may be implemented by a hardware element, a software element executed by a processor, or any combination thereof. The embodiments are not limited in this context.

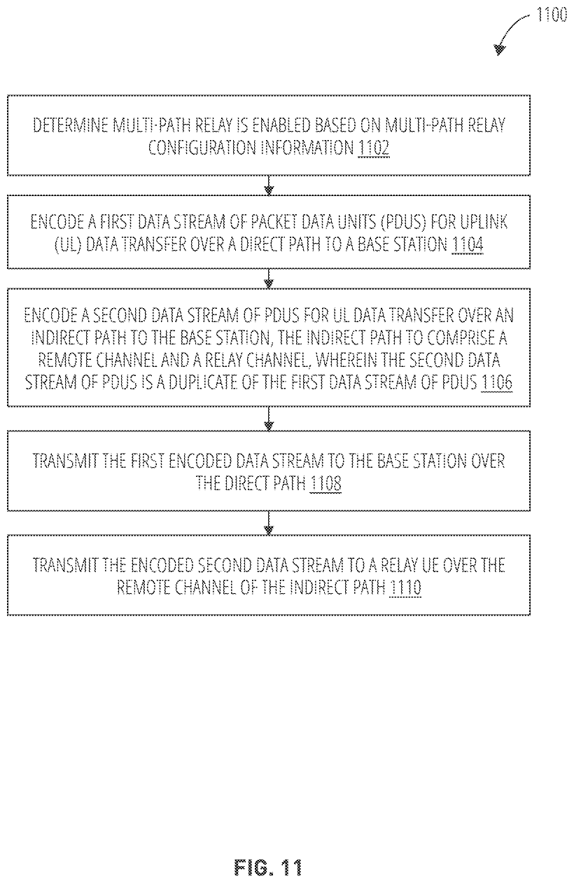

FIG. 11 illustrates an embodiment of a logic flow 1100. The logic flow 1100 may be representative of some or all of the operations executed by one or more embodiments described herein. For example, the logic flow 1100 may include some or all of the operations performed by devices or entities within the wireless communications system 100, the wireless communications system 200, and/or the wireless communications system 600, such as the remote UE 302. Embodiments are not limited in this context.

At block 1102, the logic flow 1100 determines multi-path relay is enabled based on the multi-path relay configuration information. At block 1104, logic flow 1100 encodes a first data stream of packet data units (PDUs) for uplink (UL) data transfer over a direct path to a base station. At block 1106, logic flow 1100 encodes a second data stream of PDUs for UL data transfer over an indirect path to the base station, the indirect path to comprise a remote channel and a relay channel, wherein the second data stream of PDUs is a duplicate of the first data stream of PDUs. At block 1108, logic flow 1100 transmits the encoded first data stream to the base station over the direct path. At block 1110, logic flow 1100 transmits the encoded second data stream to a relay UE over the remote channel of the indirect path, where the first RF circuitry is cellular RF circuitry and the second RF circuitry is non-cellular RF circuitry.

By way of example, the apparatus 900 for UE 202, includes a memory interface 918 to send or receive, to or from a data storage device 930, multi-path relay configuration information 704 for a wireless communications system 100, a wireless communications system 200, or a wireless communications system 600. The apparatus 900 also includes processor circuitry 904 operably coupled to the memory interface 918. The processor circuitry 904 is arranged to determine whether multi-path relay is enabled based on the multi-path relay configuration information 928. The processor circuitry 904 encodes a first data stream 432 of packet data units (PDUs) for uplink (UL) data transfer over a direct path 230 to a base station 924. The processor circuitry 904 encodes a second data stream 434 of PDUs for UL data transfer over an indirect path 232 to the base station 924. The second data stream 434 of PDUs is a duplicate of the first data stream 432 of PDUs. The indirect path 232 may comprise a remote channel 340 and a relay channel 342. The RF circuitry 922 transmits the encoded first data stream 432 to the base station 924 over the direct path 230. The RF circuitry 920 transmits the encoded second data stream 434 to a relay UE 304 over the remote channel 340 of the indirect path 232. The first RF circuitry 922 is cellular RF circuitry and the second RF circuitry 920 is non-cellular RF circuitry, or vice-versa. Embodiments are not limited to this example.

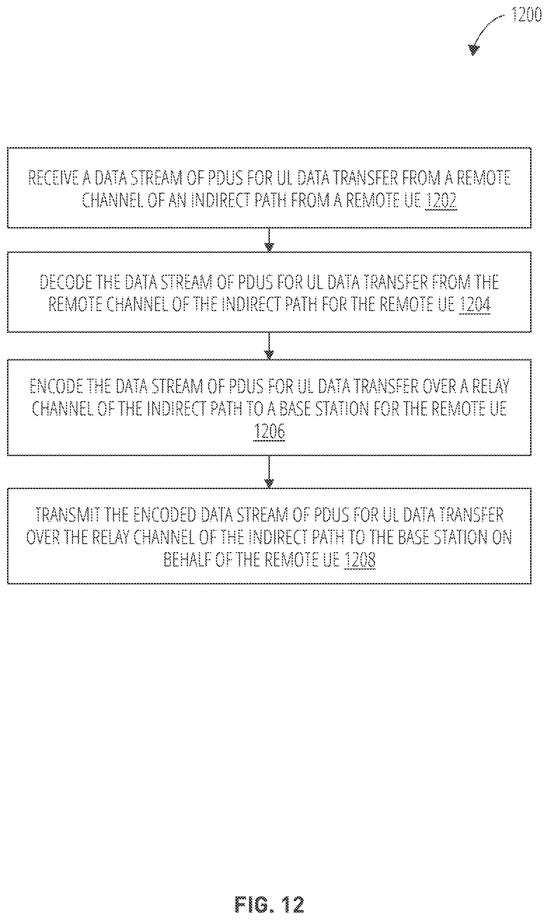

FIG. 12 illustrates an embodiment of a logic flow 1200. The logic flow 1200 may be representative of some or all of the operations executed by one or more embodiments described herein. For example, the logic flow 1200 may include some or all of the operations performed by devices or entities within the wireless communications system 100, the wireless communications system 200, and/or the wireless communications system 600, such as the relay UE 304. Embodiments are not limited in this context.

At block 1202, logic flow 1200 receives a data stream of PDUs for UL data transfer from a remote channel of an indirect path from a remote UE. At block 1204, logic flow 1200 decodes the data stream of PDUs for UL data transfer from the remote channel of the indirect path for the remote UE. At block 1206, logic flow 1200 encodes the data stream of PDUs for UL data transfer over a relay channel of the indirect path to a base station for the remote UE. At block 1208, logic flow 1200 transmits the encoded data stream of PDUs for UL data transfer over the relay channel of the indirect path to the base station on behalf of the remote UE.

By way of example, the apparatus 950 for a relay UE 304 includes a memory interface 918 to send or receive, to or from a data storage device 930, multi-path relay configuration information 704 for a wireless communications system 100, wireless communications system 200, or wireless communications system 600. The apparatus 950 also includes processor circuitry 904 operably coupled to the memory interface 918, the processor circuitry 904 to decode a data stream of PDUs for UL data transfer from a remote channel 340 of an indirect path 232 for a remote UE 302, and encode the data stream of PDUs for UL data transfer over a relay channel 342 of the indirect path 232 to a base station 924 for the remote UE 302. The processor circuitry 904 may decode a data stream of PDUs for downlink (DL) data transfer from a relay channel 342 of an indirect path 232 for a base station 924, and encode the data stream of PDUs for DL data transfer over a remote channel 340 of the indirect path 232 to a remote UE 302 for the base station 924.

The apparatus 950 may further comprise RF circuitry 920 and RF circuitry 922. The RF circuitry 920 may receive the data stream of PDUs for UL data transfer from the remote channel 340 of the indirect path 232 from the remote UE 302. The RF circuitry 922 may transmit the encoded data stream of PDUs for UL data transfer over the relay channel 342 of the indirect path 232 to the base station 924 on behalf of the remote UE 302. For example, the RF circuitry 922 is cellular RF circuitry and the RF circuitry 920 is non-cellular RF circuitry. Embodiments are not limited to this example.

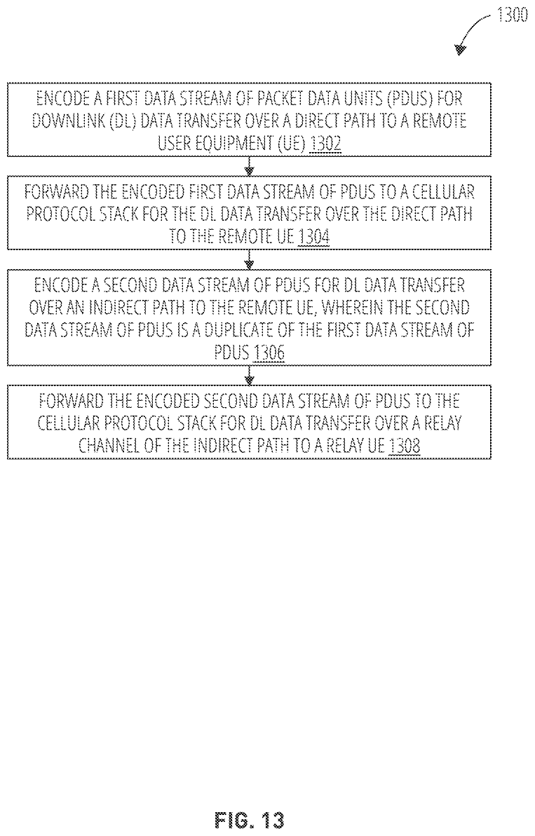

FIG. 13 illustrates an embodiment of a logic flow 1300. The logic flow 1300 may be representative of some or all of the operations executed by one or more embodiments described herein. For example, the logic flow 1300 may include some or all of the operations performed by devices or entities within the wireless communications system 100, the wireless communications system 200, and/or the wireless communications system 600, such as the base station 924. Embodiments are not limited in this context.

In block 1302, logic flow 1300 encodes a first data stream of packet data units (PDUs) for downlink (DL) data transfer over a direct path to a remote user equipment (UE). In block 1304, logic flow 1300 forwards the encoded first data stream of PDUs to a cellular protocol stack for the DL data transfer over the direct path to the remote UE. In block 1306, logic flow 1300 encodes a second data stream of PDUs for DL data transfer over an indirect path to the remote UE, wherein the second data stream of PDUs is a duplicate of the first data stream of PDUs. In block 1308, logic flow 1300 forwards the encoded second data stream of PDUs to the cellular protocol stack for DL data transfer over a relay channel of the indirect path to a relay UE.

By way of example, the apparatus 1000 may be implemented for the base station 924. For example, the apparatus 1000 for a base station 924, includes a memory interface 1030 to send or receive, to or from a data storage device 1032, multi-path relay configuration information 704 for a wireless communications system 100, wireless communications system 200, and/or wireless communications system 600. The apparatus 1000 also includes processor circuitry 1004 operably coupled to the memory interface 1030, the processor circuitry 1004 to encode a first data stream 432 of packet data units (PDUs) for downlink (DL) data transfer over a direct path to a remote UE 302, forward the encoded first data stream 432 of PDUs to a cellular protocol stack for the DL data transfer over the direct path 230 to the remote UE 302, encode a second data stream 434 of PDUs for DL data transfer over an indirect path 232 to the remote UE 302, wherein the second data stream 434 of PDUs is a duplicate of the first data stream 432 of PDUs, and forward the encoded second data stream 434 of PDUs to the cellular protocol stack for DL data transfer over a relay channel 342 of the indirect path 232 to a relay UE 304. Embodiments are not limited to this example.

FIGS. 11-14 illustrate various systems, devices and components that may implement aspects of disclosed embodiments. The systems, devices, and components may be the same, or similar to, the systems, device and components described with reference to FIG. 1 through FIG. 12.

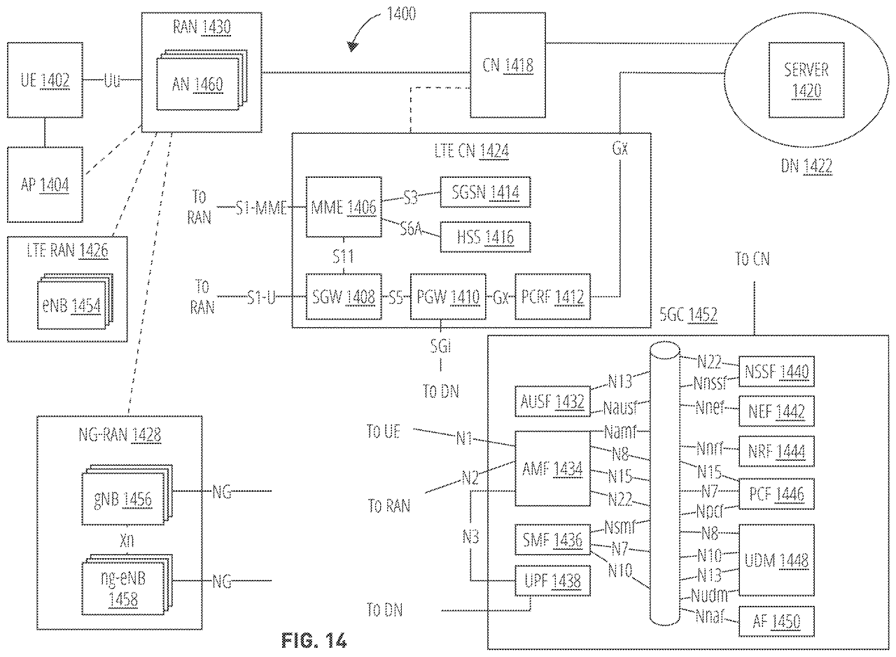

FIG. 14 illustrates a network 1400 in accordance with various embodiments. The network 1400 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 1400 may include a UE 1402, which may include any mobile or non-mobile computing device designed to communicate with a RAN 1430 via an over-the-air connection. The UE 1402 may be communicatively coupled with the RAN 1430 by a Uu interface. The UE 1402 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 1400 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 1402 may additionally communicate with an AP 1404 via an over-the-air connection. The AP 1404 may manage a WLAN connection, which may serve to offload some/all network traffic from the RAN 1430. The connection between the UE 1402 and the AP 1404 may be consistent with any IEEE 1402.11 protocol, wherein the AP 1404 could be a wireless fidelity (Wi-Fi®) router. In some embodiments, the UE 1402, RAN 1430, and AP 1404 may utilize cellular-WLAN aggregation (for example, LWA/LWIP). Cellular-WLAN aggregation may involve the UE 1402 being configured by the RAN 1430 to utilize both cellular radio resources and WLAN resources.

The RAN 1430 may include one or more access nodes, for example, AN 1460. AN 1460 may terminate air-interface protocols for the UE 1402 by providing access stratum protocols including RRC, PDCP, RLC, MAC, and L1 protocols. In this manner, the AN 1460 may enable data/voice connectivity between CN 1418 and the UE 1402. In some embodiments, the AN 1460 may be implemented in a discrete device or as one or more software entities running on server computers as part of, for example, a virtual network, which may be referred to as a CRAN or virtual baseband unit pool. The AN 1460 be referred to as a BS, gNB, RAN node, eNB, ng-eNB, NodeB, RSU, TRxP, TRP, etc. The AN 1460 may be a macrocell base station or a low power base station for providing femtocells, picocells or other like cells having smaller coverage areas, smaller user capacity, or higher bandwidth compared to macrocells.

In embodiments in which the RAN 1430 includes a plurality of ANs, they may be coupled with one another via an X2 interface (if the RAN 1430 is an LTE RAN) or an Xn interface (if the RAN 1430 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 1430 may each manage one or more cells, cell groups, component carriers, etc. to provide the UE 1402 with an air interface for network access. The UE 1402 may be simultaneously connected with a plurality of cells provided by the same or different ANs of the RAN 1430. For example, the UE 1402 and RAN 1430 may use carrier aggregation to allow the UE 1402 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 1430 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 1402 or AN 1460 may be or act as an RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally, or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 1430 may be an LTE RAN 1426 with eNBs, for example, eNB 1454. The LTE RAN 1426 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operate on sub-6 GHz bands.

In some embodiments, the RAN 1430 may be an NG-RAN 1428 with gNBs, for example, gNB 1456, or ng-eNBs, for example, ng-eNB 1458. The gNB 1456 may connect with 5G-enabled UEs using a 5G NR interface. The gNB 1456 may connect with a 5G core through an NG interface, which may include an N2 interface or an N3 interface. The ng-eNB 1458 may also connect with the 5G core through an NG interface, but may connect with a UE via an LTE air interface. The gNB 1456 and the ng-eNB 1458 may connect with each other over an Xn interface.

In some embodiments, the NG interface may be split into two parts, an NG user plane (NG-U) interface, which carries traffic data between the nodes of the NG-RAN 1428 and a UPF 1438 (e.g., N3 interface), and an NG control plane (NG-C) interface, which is a signaling interface between the nodes of the NG-RAN 1428 and an AMF 1434 (e.g., N2 interface).

The NG-RAN 1428 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operate on FR1 bands that include sub-6 GHZ bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 1402 can be configured with multiple BWPs where each BWP configuration has a different SCS. When a BWP change is indicated to the UE 1402, the SCS of the transmission is changed as well. Another use case example of BWP is related to power saving. In particular, multiple BWPs can be configured for the UE 1402 with different amount of frequency resources (for example, PRBs) to support data transmission under different traffic loading scenarios. A BWP containing a smaller number of PRBs can be used for data transmission with small traffic load while allowing power saving at the UE 1402 and in some cases at the gNB 1456. A BWP containing a larger number of PRBs can be used for scenarios with higher traffic load.

The RAN 1430 is communicatively coupled to CN 1418 that includes network elements to provide various functions to support data and telecommunications services to customers/subscribers (for example, users of UE 1402). The components of the CN 1418 may be implemented in one physical node or separate physical nodes. In some embodiments, NFV may be utilized to virtualize any or all of the functions provided by the network elements of the CN 1418 onto physical compute/storage resources in servers, switches, etc. A logical instantiation of the CN 1418 may be referred to as a network slice, and a logical instantiation of a portion of the CN 1418 may be referred to as a network sub-slice.

In some embodiments, the CN 1418 may be an LTE CN 1424, which may also be referred to as an EPC. The LTE CN 1424 may include MME 1406, SGW 1408, SGSN 1414, HSS 1416, PGW 1410, and PCRF 1412 coupled with one another over interfaces (or “reference points”) as shown. Functions of the elements of the LTE CN 1424 may be briefly introduced as follows.

The MME 1406 may implement mobility management functions to track a current location of the UE 1402 to facilitate paging, bearer activation/deactivation, handovers, gateway selection, authentication, etc.

The SGW 1408 may terminate an SI interface toward the RAN and route data packets between the RAN and the LTE CN 1424. The SGW 1408 may be a local mobility anchor point for inter-RAN node handovers and also may provide an anchor for inter-3GPP mobility. Other responsibilities may include lawful intercept, charging, and some policy enforcement.

The SGSN 1414 may track a location of the UE 1402 and perform security functions and access control. In addition, the SGSN 1414 may perform inter-EPC node signaling for mobility between different RAT networks; PDN and S-GW selection as specified by MME 1406; MME selection for handovers; etc. The S 3 reference point between the MME 1406 and the SGSN 1414 may enable user and bearer information exchange for inter-3GPP access network mobility in idle/active states.

The HSS 1416 may include a database for network users, including subscription-related information to support the network entities' handling of communication sessions. The HSS 1416 can provide support for routing/roaming, authentication, authorization, naming/addressing resolution, location dependencies, etc. An S6a reference point between the HSS 1416 and the MME 1406 may enable transfer of subscription and authentication data for authenticating/authorizing user access to the LTE CN 1418.

The PGW 1410 may terminate an SGi interface toward a data network (DN) 1422 that may include an application/content server 1420. The PGW 1410 may route data packets between the LTE CN 1424 and the data network 1422. The PGW 1410 may be coupled with the SGW 1408 by an S5 reference point to facilitate user plane tunneling and tunnel management. The PGW 1410 may further include a node for policy enforcement and charging data collection (for example, PCEF). Additionally, the SGi reference point between the PGW 1410 and the data network 1422 may be an operator external public, a private PDN, or an intra-operator packet data network, for example, for provision of IMS services. The PGW 1410 may be coupled with a PCRF 1412 via a Gx reference point.

The PCRF 1412 is the policy and charging control element of the LTE CN 1424. The PCRF 1412 may be communicatively coupled to the app/content server 1420 to determine appropriate QoS and charging parameters for service flows. The PCRF 1410 may provision associated rules into a PCEF (via Gx reference point) with appropriate TFT and QCI.

In some embodiments, the CN 1418 may be a 5GC 1452. The 5GC 1452 may include an AUSF 1432, AMF 1434, SMF 1436, UPF 1438, NSSF 1440, NEF 1442, NRF 1444, PCF 1446, UDM 1448, and AF 1450 coupled with one another over interfaces (or “reference points”) as shown. Functions of the elements of the 5GC 1452 may be briefly introduced as follows.

The AUSF 1432 may store data for authentication of UE 1402 and handle authentication-related functionality. The AUSF 1432 may facilitate a common authentication framework for various access types. In addition to communicating with other elements of the 5GC 1452 over reference points as shown, the AUSF 1432 may exhibit an Nausf service-based interface.

The AMF 1434 may allow other functions of the 5GC 1452 to communicate with the UE 1402 and the RAN 1430 and to subscribe to notifications about mobility events with respect to the UE 1402. The AMF 1434 may be responsible for registration management (for example, for registering UE 1402), connection management, reachability management, mobility management, lawful interception of AMF-related events, and access authentication and authorization. The AMF 1434 may provide transport for SM messages between the UE 1402 and the SMF 1436, and act as a transparent proxy for routing SM messages. AMF 1434 may also provide transport for SMS messages between UE 1402 and an SMSF. AMF 1434 may interact with the AUSF 1432 and the UE 1402 to perform various security anchor and context management functions. Furthermore, AMF 1434 may be a termination point of a RAN CP interface, which may include or be an N2 reference point between the RAN 1430 and the AMF 1434; and the AMF 1434 may be a termination point of NAS (N1) signaling, and perform NAS ciphering and integrity protection. AMF 1434 may also support NAS signaling with the UE 1402 over an N3 IWF interface.

The SMF 1436 may be responsible for SM (for example, session establishment, tunnel management between UPF 1438 and AN 1460); UE IP address allocation and management (including optional authorization); selection and control of UP function; configuring traffic steering at UPF 1438 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 1434 over N2 to AN 1460; and determining SSC mode of a session. SM may refer to management of a PDU session, and a PDU session or “session” may refer to a PDU connectivity service that provides or enables the exchange of PDUs between the UE 1402 and the data network 1422.

The UPF 1438 may act as an anchor point for intra-RAT and inter-RAT mobility, an external PDU session point of interconnect to data network 1422, and a branching point to support multi-homed PDU session. The UPF 1438 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 1438 may include an uplink classifier to support routing traffic flows to a data network.

The NSSF 1440 may select a set of network slice instances serving the UE 1402. The NSSF 1440 may also determine allowed NSSAI and the mapping to the subscribed S-NSSAIs, if needed. The NSSF 1440 may also determine the AMF set to be used to serve the UE 1402, or a list of candidate AMFs based on a suitable configuration and possibly by querying the NRF 1444. The selection of a set of network slice instances for the UE 1402 may be triggered by the AMF 1434 with which the UE 1402 is registered by interacting with the NSSF 1440, which may lead to a change of AMF. The NSSF 1440 may interact with the AMF 1434 via an N22 reference point; and may communicate with another NSSF in a visited network via an N31 reference point (not shown). Additionally, the NSSF 1440 may exhibit an Nnssf service-based interface.

The NEF 1442 may securely expose services and capabilities provided by 3GPP network functions for third party, internal exposure/re-exposure, AFs (e.g., AF 1450), edge computing or fog computing systems, etc. In such embodiments, the NEF 1442 may authenticate, authorize, or throttle the AFs. NEF 1442 may also translate information exchanged with the AF 1450 and information exchanged with internal network functions. For example, the NEF 1442 may translate between an AF-Service-Identifier and an internal 5GC information. NEF 1442 may also receive information from other NFs based on exposed capabilities of other NFs. This information may be stored at the NEF 1442 as structured data, or at a data storage NF using standardized interfaces. The stored information can then be re-exposed by the NEF 1442 to other NFs and AFs, or used for other purposes such as analytics. Additionally, the NEF 1442 may exhibit an Nnef service-based interface.

The NRF 1444 may support service discovery functions, receive NF discovery requests from NF instances, and provide the information of the discovered NF instances to the NF instances. NRF 1444 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 1444 may exhibit the Nnrf service-based interface.

The PCF 1446 may provide policy rules to control plane functions to enforce them, and may also support unified policy framework to govern network behavior. The PCF 1446 may also implement a front end to access subscription information relevant for policy decisions in a UDR of the UDM 1448. In addition to communicating with functions over reference points as shown, the PCF 1446 exhibit an Npcf service-based interface.

The UDM 1448 may handle subscription-related information to support the network entities' handling of communication sessions, and may store subscription data of UE 1402. For example, subscription data may be communicated via an N8 reference point between the UDM 1448 and the AMF 1434. The UDM 1448 may include two parts, an application front end and a UDR. The UDR may store subscription data and policy data for the UDM 1448 and the PCF 1446, and/or structured data for exposure and application data (including PFDs for application detection, application request information for multiple UEs 1402) for the NEF 1442. The Nudr service-based interface may be exhibited by the UDR 221 to allow the UDM 1448, PCF 1446, and NEF 1442 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 1448 may exhibit the Nudm service-based interface.

The AF 1450 may provide application influence on traffic routing, provide access to NEF, and interact with the policy framework for policy control.

In some embodiments, the 5GC 1452 may enable edge computing by selecting operator/3^{rd} party services to be geographically close to a point that the UE 1402 is attached to the network. This may reduce latency and load on the network. To provide edge-computing implementations, the 5GC 1452 may select a UPF 1438 close to the UE 1402 and execute traffic steering from the UPF 1438 to data network 1422 via the N6 interface. This may be based on the UE subscription data, UE location, and information provided by the AF 1450. In this way, the AF 1450 may influence UPF (re)selection and traffic routing. Based on operator deployment, when AF 1450 is considered to be a trusted entity, the network operator may permit AF 1450 to interact directly with relevant NFs. Additionally, the AF 1450 may exhibit a Naf service-based interface.

The data network 1422 may represent various network operator services, Internet access, or third party services that may be provided by one or more servers including, for example, application/content server 1420.

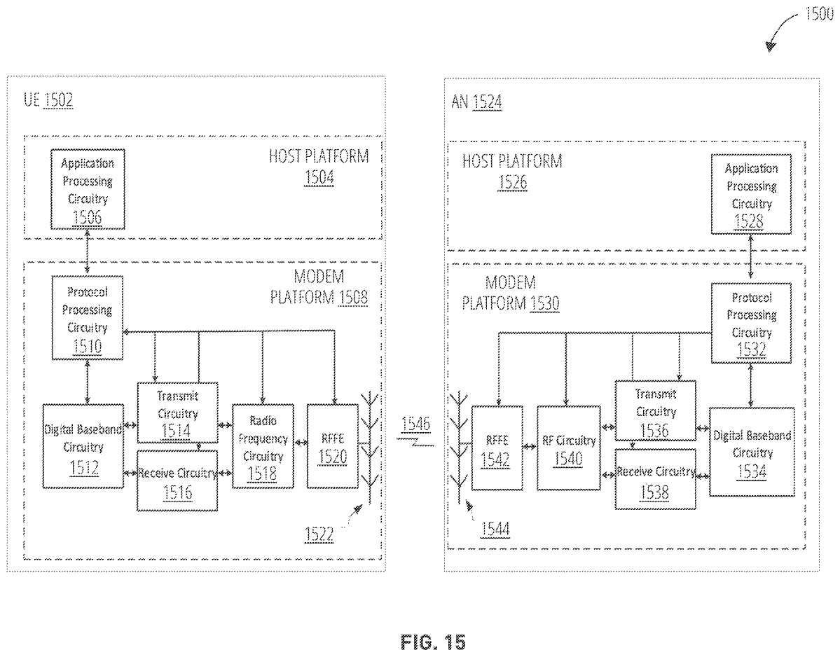

FIG. 15 schematically illustrates a wireless network 1500 in accordance with various embodiments. The wireless network 1500 may include a UE 1502 in wireless communication with an AN 1524. The UE 1502 and AN 1524 may be similar to, and substantially interchangeable with, like-named components described elsewhere herein.

The UE 1502 may be communicatively coupled with the AN 1524 via connection 1546. The connection 1546 is illustrated as an air interface to enable communicative coupling, and can be consistent with cellular communications protocols such as an LTE protocol or a 5G NR protocol operating at mmWave or sub-6GHZ frequencies.

The UE 1502 may include a host platform 1504 coupled with a modem platform 1508. The host platform 1504 may include application processing circuitry 1506, which may be coupled with protocol processing circuitry 1510 of the modem platform 1508. The application processing circuitry 1506 may run various applications for the UE 1502 that source/sink application data. The application processing circuitry 1506 may further implement one or more layer operations to transmit/receive application data to/from a data network. These layer operations may include transport (for example UDP) and Internet (for example, IP) operations The protocol processing circuitry 1510 may implement one or more of layer operations to facilitate transmission or reception of data over the connection 1546. The layer operations implemented by the protocol processing circuitry 1510 may include, for example, MAC, RLC, PDCP, RRC and NAS operations.

The modem platform 1508 may further include digital baseband circuitry 1512 that may implement one or more layer operations that are “below” layer operations performed by the protocol processing circuitry 1510 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 1508 may further include transmit circuitry 1514, receive circuitry 1516, RF circuitry 1518, and RF front end (RFFE) 1520, which may include or connect to one or more antenna panels 1522. Briefly, the transmit circuitry 1514 may include a digital-to-analog converter, mixer, intermediate frequency (IF) components, etc.; the receive circuitry 1516 may include an analog-to-digital converter, mixer, IF components, etc. ; the RF circuitry 1518 may include a low-noise amplifier, a power amplifier, power tracking components, etc.; RFFE 1520 may include filters (for example, surface/bulk acoustic wave filters), switches, antenna tuners, beamforming components (for example, phase-array antenna components), etc. The selection and arrangement of the components of the transmit circuitry 1514, receive circuitry 1516, RF circuitry 1518, RFFE 1520, and antenna panels 1522 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 1510 may include one or more instances of control circuitry (not shown) to provide control functions for the transmit/receive components.

A UE reception may be established by and via the antenna panels 1522, RFFE 1520, RF circuitry 1518, receive circuitry 1516, digital baseband circuitry 1512, and protocol processing circuitry 1510. In some embodiments, the antenna panels 1522 may receive a transmission from the AN 1524 by receive-beamforming signals received by a plurality of antennas/antenna elements of the one or more antenna panels 1522.

A UE transmission may be established by and via the protocol processing circuitry 1510, digital baseband circuitry 1512, transmit circuitry 1514, RF circuitry 1518, RFFE 1520, and antenna panels 1522. In some embodiments, the transmit components of the UE 1524 may apply a spatial filter to the data to be transmitted to form a transmit beam emitted by the antenna elements of the antenna panels 1522.

Similar to the UE 1502, the AN 1524 may include a host platform 1526 coupled with a modem platform 1530. The host platform 1526 may include application processing circuitry 1528 coupled with protocol processing circuitry 1532 of the modem platform 1530. The modem platform may further include digital baseband circuitry 1534, transmit circuitry 1536, receive circuitry 1538, RF circuitry 1540, RFFE circuitry 1542, and antenna panels 1544. The components of the AN 1524 may be similar to and substantially interchangeable with like-named components of the UE 1502. In addition to performing data transmission/reception as described above, the components of the A 1504 may perform various logical functions that include, for example, RNC functions such as radio bearer management, uplink and downlink dynamic radio resource management, and data packet scheduling.

FIG. 16 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 16 shows a diagrammatic representation of hardware resources 1630 including one or more processors (or processor cores) 1610, one or more memory/storage devices 1622, and one or more communication resources 1626, each of which may be communicatively coupled via a bus 1620 or other interface circuitry. For embodiments where node virtualization (e.g., NFV) is utilized, a hypervisor 1602 may be executed to provide an execution environment for one or more network slices/sub-slices to utilize the hardware resources 1630.

The processors 1610 may include, for example, a processor 1612 and a processor 1614. The processors 1610 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 1622 may include main memory, disk storage, or any suitable combination thereof. The memory/storage devices 1622 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 1626 may include interconnection or network interface controllers, components, or other suitable devices to communicate with one or more peripheral devices 1604 or one or more databases 1606 or other network elements via a network 1608. For example, the communication resources 1626 may include wired communication components (e.g., for coupling via USB, Ethernet, etc.), cellular communication components, NFC components, Bluetooth® (or Bluetooth® Low Energy) components, Wi-Fi® components, and other communication components.

Instructions 106, 1618, 1624, 1628, 1632 may comprise software, a program, an application, an applet, an app, or other executable code for causing at least any of the processors 1610 to perform any one or more of the methodologies discussed herein. The instructions 106, 1618, 1624, 1628, 1632 may reside, completely or partially, within at least one of the processors 1610 (e.g., within the processor's cache memory), the memory/storage devices 1622, or any suitable combination thereof. Furthermore, any portion of the instructions 106, 1618, 1624, 1628, 1632 may be transferred to the hardware resources 1630 from any combination of the peripheral devices 1604 or the databases 1606. Accordingly, the memory of processors 1610, the memory/storage devices 1622, the peripheral devices 1604, and the databases 1606 are examples of computer-readable and machine-readable media.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

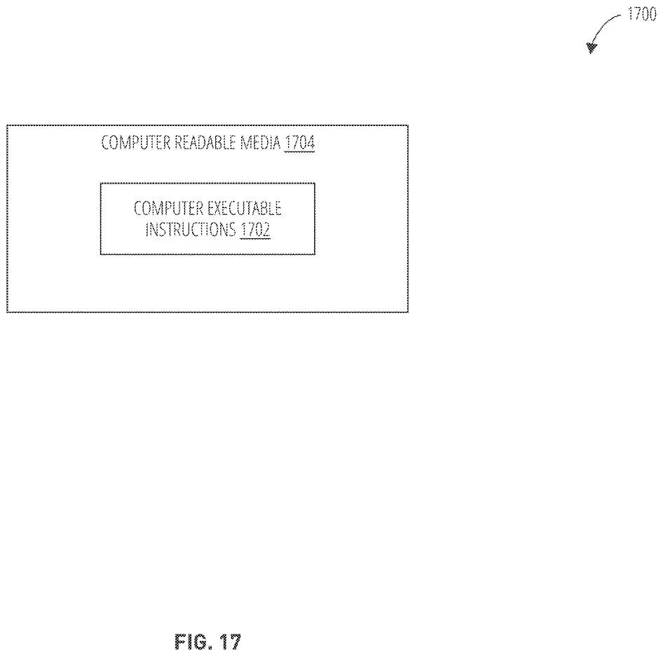

FIG. 17 illustrates computer readable storage medium 1700. Computer readable storage medium 1700 may comprise any non-transitory computer-readable storage medium or machine-readable storage medium, such as an optical, magnetic or semiconductor storage medium. In various embodiments, computer readable storage medium 1700 may comprise an article of manufacture. In some embodiments, computer readable storage medium 1700 may store computer executable instructions 1702 with which circuitry can execute. For example, computer executable instructions 1702 can include computer executable instructions 1702 to implement operations described with respect to logic flow 1100 and/or logic flow 1100. Examples of computer readable storage medium 1700 or machine-readable storage medium 1700 may include any tangible media capable of storing electronic data, including volatile memory or non-volatile memory, removable or non-removable memory, erasable or non-erasable memory, writeable or re-writeable memory, and so forth. Examples of computer executable instructions 1702 may include any suitable type of code, such as source code, compiled code, interpreted code, executable code, static code, dynamic code, object-oriented code, visual code, and the like.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

At least one computer-readable storage medium may include instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

The various elements of the devices as previously described with reference to FIGS. 1-17 may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

At least one computer-readable storage medium may include instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

The following examples pertain to further embodiments, from which numerous permutations and configurations will be apparent.

### EXAMPLE SET 1

Additional examples of the presently described methods, devices, systems, and networks discussed herein include the following, non-limiting implementations. Each of the following non-limiting examples may stand on its own or may be combined in any permutation or combination with any one or more of the other examples provided below or throughout the present disclosure.

Example 1 includes a method that allows at least two paths of communication between a UE and the network wherein one path is indirect via a forwarding/relay UE, to relay information (control and user plane) between the remote UE and the network and another path is direct via Uu link wherein the remote UE and relay UE belong to the same gNB but could be on the same or different cell.

Example 2 includes the method of example 1 and/or some other example(s) herein, wherein a remote UE or relay UE may inform the gNB of the ideal indirect path between them.

Example 3 includes the method of examples 1-2 and/or some other example(s) herein, wherein an indication for enabling multi-path for peer link is configured on a per bearer basis for UEs using peer link as one of the paths.

Example 4 includes the method of example 3 and/or some other example(s) herein, wherein the downlink data received from the gNB on specific configured ingress Uu RLC channels are delivered to the UE's peer link protocol stack.

Example 5 includes the method of examples 3-4 and/or some other example(s) herein, wherein the uplink data from the UE from specific transmitting PDCP entity/radio bearer ID is duplicated if configured and one copy is delivered to the UE's peer link protocol stack.

Example 6 includes the method of example 5 and/or some other example(s) herein, wherein the duplicated uplink packet is carried in the egress RLC channel to be delivered to the gNB.

Example 7 includes the method of examples 3-6 and/or some other example(s) herein, wherein the gNB releases the configuration of the failed path and/or available path upon receiving failure information of the direct path.

Example 8 includes the method of examples 3-7 and/or some other example(s) herein, wherein the gNB suspends the data transmission and reception for all radio bearers upon receiving failure information of the direct path.

Example 9 includes a method to support PDCP duplication in downlink for multi-path transmission using a Uu link and an indirect path using an ideal UE-UE connection.

Example 10 includes the method of example 9 and/or some other example(s) herein, wherein t-Reordering timer is pre-empted in the event of link failure indication for ideal UE-UE connection.

Example 11 includes the method of examples 9-10 and/or some other example(s) herein, wherein the gNB triggers a PDCP status report in the event of link failure indication for ideal UE-UE connection to proceed with the PDCP data recovery process.

Example 12 includes a method that allows end-to-end lossless delivery for inter-gNB path switching using UE to Network Relay

Example 13 includes the method of example 12 and/or some other example(s) herein, wherein the L2 U2N relay UE is made aware of the path switch command sent from the gNB to the Remote UE

Example 14 includes the method of examples 12-13 and/or some other example(s) herein, wherein the L2 U2N relay UE provides a status update to the source gNB of any packets which have not been transmitted over the second hop in downlink.

Example 15 includes the method of examples 12-14 and/or some other example(s) herein, wherein the L2 U2N relay UE provides a status update to the L2 U2N Remote UE of any packets which have not been transmitted over the second hop in uplink.

Example 16 includes the method of examples 12-15 and/or some other example(s) herein, wherein path switching triggers a status report to the source gNB from the Remote UE before the source gNB performs SN status transfer to the target gNB.

Example 17 includes the method of examples 12-16 and/or some other example(s) herein, wherein the method includes employing data buffering at the U2N Relay UE to buffer data for the remote UE during inter-gNB path switching

Example 18 includes the method of example 17 and/or some other example(s) herein, wherein a new timer is introduced to dictate the duration of time for which the remote UE's data is buffered

Example 19 includes the method of examples 17-18 and/or some other example(s) herein, wherein a new capability for Relay UE is introduced to configure whether the relay UE supports data buffering or not.

Example 19 includes the method of examples 12-19 and/or some other example(s) herein, wherein PC5 link is maintained in indirect to direct inter-gNB path switching until PDCP data recovery process is complete.

Example 20 includes a method of Layer 2 UE-to-UE relaying for UE coverage extension supports report of link failure information to the source UE to enable failure handling of relay reselection as an example.

Example 21 includes the method of example 20 and/or some other example(s) herein, wherein the method includes any one or more of examples 1-19.

### EXAMPLE SET 2

In one aspect, an apparatus for a user equipment (UE), includes a memory interface to send or receive, to or from a data storage device, multi-path relay configuration information for a wireless communications system. The apparatus also includes processor circuitry operably coupled to the memory interface, the processor circuitry to determine multi-path relay is enabled based on the multi-path relay configuration information, encode a first data stream of packet data units (PDUs) for uplink (UL) data transfer over a direct path to a base station, and encode a second data stream of PDUs for UL data transfer over an indirect path to the base station, the indirect path to comprise a remote channel and a relay channel, where the second data stream of PDUs is a duplicate of the first data stream of PDUs.

The apparatus may also include the processor circuitry to forward the encoded first data stream of PDUs to a cellular protocol stack for UL data transfer over the direct path to the base station.

The apparatus may also include the processor circuitry to forward the encoded second data stream of PDUs to a non-cellular protocol stack for UL data transfer over the remote channel of the indirect path to a relay UE. The apparatus may also include where the direct path traverses a single communication link and the indirect path traverses multiple communication links.

The apparatus may also include where the remote channel is a non-cellular channel using a non-cellular protocol stack and the relay channel is a cellular channel using a cellular protocol stack.

The apparatus may also include where the remote channel is between a remote UE and a relay UE, and the relay channel is between the relay UE and the base station.

The apparatus may also include the processor circuitry to: decode a third data stream of packet data units (PDUs) for downlink (DL) data transfer over the direct path from the base station, decode a fourth data stream of PDUs for DL data transfer over the remote channel of the indirect path from the base station, where the fourth data stream of PDUs is a duplicate of the third data stream of PDUs, and generate a fifth data stream from the third data stream of PDUs and the fourth data stream of PDUs.

The apparatus may also include the processor circuitry to detect radio link failure (RLF) on the direct path or the indirect path, generate a path failure report to indicate the RLF of the direct path or the indirect path, and encode the path failure report for UL data transfer over the direct path to the base station when the RLF is for the indirect path; or encode the path failure report for UL data transfer over the indirect path to the base station when the RLF is for the direct path.

The apparatus may also include includes a first radio-frequency (RF) circuitry to transmit the encoded first data stream as RF signals to the base station over the direct path, and a second RF circuitry to transmit the encoded second data stream as RF signals to a relay UE over the remote channel of the indirect path, where the first RF circuitry is cellular RF circuitry and the second RF circuitry is non-cellular RF circuitry.

In one aspect, an apparatus for a user equipment (UE), includes a memory interface to send or receive, to or from a data storage device, multi-path relay configuration information for a wireless communications system.

The apparatus also includes processor circuitry operably coupled to the memory interface, the processor circuitry to decode a data stream of PDUs for UL data transfer from a remote channel of an indirect path for a remote UE, and encode the data stream of PDUs for UL data transfer over a relay channel of the indirect path to a base station for the remote UE.

The apparatus may also include the processor circuitry to decode a data stream of PDUs for downlink (DL) data transfer from a relay channel of an indirect path for a base station, and encode the data stream of PDUs for DL data transfer over a remote channel of the indirect path to a remote UE for the base station.

In one aspect, an apparatus for a base station, includes a memory interface to send or receive, to or from a data storage device, multi-path relay configuration information for a wireless communications system.

The apparatus also includes processor circuitry operably coupled to the memory interface, the processor circuitry to encode a first data stream of packet data units (PDUs) for downlink (DL) data transfer over a direct path to a remote user equipment (UE), forward the encoded first data stream of PDUs to a cellular protocol stack for the DL data transfer over the direct path to the remote UE, encode a second data stream of PDUs for DL data transfer over an indirect path to the remote UE, where the second data stream of PDUs is a duplicate of the first data stream of PDUs, and forward the encoded second data stream of PDUs to the cellular protocol stack for DL data transfer over a relay channel of the indirect path to a relay UE.

The apparatus may also include the processor circuitry to decode a third data stream of PDUs for uplink (UL) data transfer over the direct path from the remote UE, decode a fourth data stream of PDUs for UL data transfer over the relay channel of the indirect path from a relay UE on behalf of the remote UE, where the fourth data stream of PDUs is a duplicate of the third data stream of PDUs, and generate a fifth data stream from the third data stream of PDUs and the fourth data stream of PDUs.

The apparatus may also include the processor circuitry to remove duplicate PDUs from the third data stream and the fourth data stream to generate the fifth data stream.

The apparatus may also include the processor circuitry to perform packet reordering to reorder PDUs from the third data stream or the fourth data stream according to a sequence number for each PDU to generate the fifth data stream in a sequential order. Other technical features may be readily apparent to one skilled in the art from the following In one aspect, a method for a user equipment (UE), includes determining multi-path relay is enabled based on multi-path relay configuration information, encoding a first data stream of packet data units (PDUs) for uplink (UL) data transfer over a direct path to a base station, and encode a second data stream of PDUs for UL data transfer over an indirect path to the base station, the indirect path to comprise a remote channel and a relay channel, where the second data stream of PDUs is a duplicate of the first data stream of PDUs.

The method may also include includes forwarding the encoded first data stream of PDUs to a cellular protocol stack for UL data transfer over the direct path to the base station.

The method may also include includes forwarding the encoded second data stream of PDUs to a non-cellular protocol stack for UL data transfer over the remote channel of the indirect path to a relay UE.

The method may also include where the direct path traverses a single communication link and the indirect path traverses multiple communication links.

The method may also include where the remote channel is a non-cellular channel using a non-cellular protocol stack and the relay channel is a cellular channel using a cellular protocol stack.

The method may also include where the remote channel is between a remote UE and a relay UE, and the relay channel is between the relay UE and the base station.

The method may also include includes: decoding a third data stream of packet data units (PDUs) for downlink (DL) data transfer over the direct path from the base station, decoding a fourth data stream of PDUs for DL data transfer over the remote channel of the indirect path from the base station, where the fourth data stream of PDUs is a duplicate of the third data stream of PDUs, and generating a fifth data stream from the third data stream of PDUs and the fourth data stream of PDUs.

The method may also include includes removing duplicate PDUs from the third data stream and the fourth data stream to generate the fifth data stream.

The method may also include includes performing packet reordering to reorder PDUs from the third data stream or the fourth data stream according to a sequence number for each PDU to generate the fifth data stream in a sequential order.

The method may also include includes detecting radio link failure (RLF) on the direct path or the indirect path, generating a path failure report to indicate the RLF of the direct path or the indirect path, and encoding the path failure report for UL data transfer over the direct path to the base station when the RLF is for the indirect path; or encoding the path failure report for UL data transfer over the indirect path to the base station when the RLF is for the direct path.

The method may also include includes transmitting the encoded first data stream as radio-frequency (RF) signals to the base station over the direct path, and transmitting the encoded second data stream as RF signals to a relay UE over the remote channel of the indirect path, where the first RF circuitry is cellular RF circuitry and the second RF circuitry is non-cellular RF circuitry.

In one aspect, a method for a user equipment (UE), includes decoding a data stream of PDUs for UL data transfer from a remote channel of an indirect path for a remote UE, and encoding the data stream of PDUs for UL data transfer over a relay channel of the indirect path to a base station for the remote UE.

The method may also include includes decoding a data stream of PDUs for downlink (DL) data transfer from a relay channel of an indirect path for a base station, and encoding the data stream of PDUs for DL data transfer over a remote channel of the indirect path to a remote UE for the base station.

In one aspect, a non-transitory machine-readable storage medium, the machine-readable storage medium including instructions that when executed by circuitry, cause the circuity to determine multi-path relay is enabled based on multi-path relay configuration information, encode a first data stream of packet data units (PDUs) for uplink (UL) data transfer over a direct path to a base station, and encode a second data stream of PDUs for UL data transfer over an indirect path to the base station, the indirect path to comprise a remote channel and a relay channel, where the second data stream of PDUs is a duplicate of the first data stream of PDUs.

The machine-readable storage medium may also include includes instructions that when executed by the circuitry causes the circuitry to forward the encoded first data stream of PDUs to a cellular protocol stack for UL data transfer over the direct path to the base station.

The machine-readable storage medium may also include includes instructions that when executed by the circuitry causes the circuitry to forward the encoded second data stream of PDUs to a non-cellular protocol stack for UL data transfer over the remote channel of the indirect path to a relay UE.

The machine-readable storage medium may also include where the direct path traverses a single communication link and the indirect path traverses multiple communication links.

The machine-readable storage medium may also include where the remote channel is a non-cellular channel using a non-cellular protocol stack and the relay channel is a cellular channel using a cellular protocol stack.

The machine-readable storage medium may also include where the remote channel is between a remote UE and a relay UE, and the relay channel is between the relay UE and the base station.

The machine-readable storage medium may also include includes instructions that when executed by the circuitry causes the circuitry to: decode a third data stream of packet data units (PDUs) for downlink (DL) data transfer over the direct path from the base station, decode a fourth data stream of PDUs for DL data transfer over the remote channel of the indirect path from the base station, where the fourth data stream of PDUs is a duplicate of the third data stream of PDUs, and generate a fifth data stream from the third data stream of PDUs and the fourth data stream of PDUs.

The machine-readable storage medium may also include includes instructions that when executed by the circuitry causes the circuitry to remove duplicate PDUs from the third data stream and the fourth data stream to generate the fifth data stream.

The machine-readable storage medium may also include includes instructions that when executed by the circuitry causes the circuitry to perform packet reordering to reorder PDUs from the third data stream or the fourth data stream according to a sequence number for each PDU to generate the fifth data stream in a sequential order.

The machine-readable storage medium may also include includes instructions that when executed by the circuitry causes the circuitry to detect radio link failure (RLF) on the direct path or the indirect path, generate a path failure report to indicate the RLF of the direct path or the indirect path, and encode the path failure report for UL data transfer over the direct path to the base station when the RLF is for the indirect path; or encode the path failure report for UL data transfer over the indirect path to the base station when the RLF is for the direct path.

The machine-readable storage medium may also include includes instructions that when executed by the circuitry causes the circuitry to transmit the encoded first data stream as radio-frequency (RF) signals to the base station over the direct path, and transmit the encoded second data stream as RF signals to a relay UE over the remote channel of the indirect path, where the first RF circuitry is cellular RF circuitry and the second RF circuitry is non-cellular RF circuitry.

In one aspect, a non-transitory machine-readable storage medium, the machine-readable storage medium including instructions that when executed by circuitry, cause the circuity to decode a data stream of PDUs for UL data transfer from a remote channel of an indirect path for a remote UE, and encode the data stream of PDUs for UL data transfer over a relay channel of the indirect path to a base station for the remote UE.

The machine-readable storage medium may also include includes instructions that when executed by the circuitry causes the circuitry to decode a data stream of PDUs for downlink (DL) data transfer from a relay channel of an indirect path for a base station, and encode the data stream of PDUs for DL data transfer over a remote channel of the indirect path to a remote UE for the base station.

The apparatus may also include the processor circuitry to remove duplicate PDUs from the third data stream and the fourth data stream to generate the fifth data stream.

The apparatus may also include the processor circuitry to perform packet reordering to reorder PDUs from the third data stream or the fourth data stream according to a sequence number for each PDU to generate the fifth data stream in a sequential order.

The apparatus may also include includes a first radio-frequency (RF) circuitry to transmit RF signals representing the encoded data stream of PDUs for UL data transfer over the relay channel of the indirect path to the base station on behalf of the remote UE, and a second RF circuitry to receive RF signals representing the data stream of PDUs for UL data transfer from the remote channel of the indirect path from the remote UE, where the first RF circuitry is cellular RF circuitry and the second RF circuitry is non-cellular RF circuitry.

The method may also include includes transmitting radio-frequency (RF) signals representing the encoded data stream of PDUs for UL data transfer over the relay channel of the indirect path to the base station on behalf of the remote UE, and receiving RF signals representing the data stream of PDUs for UL data transfer from the remote channel of the indirect path from the remote UE, where the first RF circuitry is cellular RF circuitry and the second RF circuitry is non-cellular RF circuitry.

The machine-readable storage medium may also include includes instructions that when executed by the circuitry causes the circuitry to transmit radio-frequency (RF) signals representing the encoded data stream of PDUs for UL data transfer over the relay channel of the indirect path to the base station on behalf of the remote UE, and receive RF signals representing the data stream of PDUs for UL data transfer from the remote channel of the indirect path from the remote UE, where the first RF circuitry is cellular RF circuitry and the second RF circuitry is non-cellular RF circuitry.

### Terminology

For the purposes of the present document, the following terms and definitions are applicable to the examples and embodiments discussed herein.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to providing a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

The term “SMTC” refers to an SSB-based measurement timing configuration configured by SSB-MeasurementTiming Configuration.

The term “SSB” refers to an SS/PBCH block.

The term “a “Primary Cell” refers to the MCG cell, operating on the primary frequency, in which the UE either performs the initial connection establishment procedure or initiates the connection re-establishment procedure.

The term “Primary SCG Cell” refers to the SCG cell in which the UE performs random access when performing the Reconfiguration with Sync procedure for DC operation.

The term “Secondary Cell” refers to a cell providing additional radio resources on top of a Special Cell for a UE configured with CA.

The term “Secondary Cell Group” refers to the subset of serving cells comprising the PSCell and zero or more secondary cells for a UE configured with DC.

The term “Serving Cell” refers to the primary cell for a UE in RRC_CONNECTED not configured with CA/DC there is only one serving cell comprising of the primary cell.

The term “serving cell” or “serving cells” refers to the set of cells comprising the Special Cell(s) and all secondary cells for a UE in RRC_CONNECTED configured with CA/.

The term “Special Cell” refers to the PCell of the MCG or the PSCell of the SCG for DC operation; otherwise, the term “Special Cell” refers to the Pcell.

1-20. (canceled)

21. An apparatus for a user equipment (UE), comprising:
a memory interface to send or receive, to or from a data storage device, multi-path relay configuration information for a wireless communications system; and
processor circuitry operably coupled to the memory interface, the processor circuitry to:
determine multi-path relay is enabled based on the multi-path relay configuration information;
encode a first data stream of packet data units (PDUs) for uplink (UL) data transfer over a direct path to a base station; and
encode a second data stream of PDUs for UL data transfer over an indirect path to the base station, the indirect path to comprise a remote channel and a relay channel, wherein the second data stream of PDUs is a duplicate of the first data stream of PDUs.

22. The apparatus of claim 21, wherein the remote channel is a non-cellular channel using a non-cellular protocol stack and the relay channel is a cellular channel using a cellular protocol stack.

23. The apparatus of claim 21, the processor circuitry to:
forward the encoded first data stream of PDUs to a cellular protocol stack for UL data transfer over the direct path to the base station; and
forward the encoded second data stream of PDUs to a non-cellular protocol stack for UL data transfer over the remote channel of the indirect path to a relay UE.

24. The apparatus of claim 21, the processor circuitry to:
decode a third data stream of packet data units (PDUs) for downlink (DL) data transfer over the direct path from the base station;
decode a fourth data stream of PDUs for DL data transfer over the remote channel of the indirect path from the base station via a relay UE, wherein the fourth data stream of PDUs is a duplicate of the third data stream of PDUs; and
generate a fifth data stream from the third data stream of PDUs and the fourth data stream of PDUs.

25. The apparatus of claim 24, the processor circuitry to remove duplicate PDUs from the third data stream and the fourth data stream to generate the fifth data stream.

26. The apparatus of claim 24, the processor circuitry to perform packet reordering to reorder PDUs from the third data stream or the fourth data stream according to a sequence number for each PDU to generate the fifth data stream in a sequential order.

27. The apparatus of claim 21, the processor circuitry to:
detect radio link failure (RLF) on the direct path or the indirect path;
generate a path failure report to indicate the RLF of the direct path or the indirect path; and
encode the path failure report for UL data transfer over the direct path to the base station when the RLF is for the indirect path; or
encode the path failure report for UL data transfer over the indirect path to the base station when the RLF is for the direct path.

28. A method for a user equipment (UE), comprising:
determining multi-path relay is enabled based on multi-path relay configuration information;
encoding a first data stream of packet data units (PDUs) for uplink (UL) data transfer over a direct path to a base station; and
encoding a second data stream of PDUs for UL data transfer over an indirect path to the base station, the indirect path to comprise a remote channel and a relay channel, wherein the second data stream of PDUs is a duplicate of the first data stream of PDUs.

29. The method of claim 28, wherein the remote channel is a non-cellular channel using a non-cellular protocol stack and the relay channel is a cellular channel using a cellular protocol stack.

30. The method of claim 28, comprising:
forwarding the encoded first data stream of PDUs to a cellular protocol stack for UL data transfer over the direct path to the base station; and
forwarding the encoded second data stream of PDUs to a non-cellular protocol stack for UL data transfer over the remote channel of the indirect path to a relay UE.

31. The method of claim 28, comprising:
decoding a third data stream of packet data units (PDUs) for downlink (DL) data transfer over the direct path from the base station;
decoding a fourth data stream of PDUs for DL data transfer over the remote channel of the indirect path from the base station via a relay UE, wherein the fourth data stream of PDUs is a duplicate of the third data stream of PDUs; and
generating a fifth data stream from the third data stream of PDUs and the fourth data stream of PDUs.

32. The method of claim 28, comprising removing duplicate PDUs from the third data stream and the fourth data stream to generate the fifth data stream.

33. The method of claim 28, comprising performing packet reordering to reorder PDUs from the third data stream or the fourth data stream according to a sequence number for each PDU to generate the fifth data stream in a sequential order.

34. The method of claim 28, comprising:
detecting radio link failure (RLF) on the direct path or the indirect path;
generating a path failure report to indicate the RLF of the direct path or the indirect path; and
encoding the path failure report for UL data transfer over the direct path to the base station when the RLF is for the indirect path; or
encoding the path failure report for UL data transfer over the indirect path to the base station when the RLF is for the direct path.

35. A machine-readable storage medium, the machine-readable storage medium including instructions that when executed by circuitry, cause the circuity to:
determine multi-path relay is enabled based on multi-path relay configuration information;
encode a first data stream of packet data units (PDUs) for uplink (UL) data transfer over a direct path to a base station; and
encode a second data stream of PDUs for UL data transfer over an indirect path to the base station, the indirect path to comprise a remote channel and a relay channel, wherein the second data stream of PDUs is a duplicate of the first data stream of PDUs.

36. The machine-readable storage medium of claim 35, wherein the remote channel is a non-cellular channel using a non-cellular protocol stack and the relay channel is a cellular channel using a cellular protocol stack.

37. The machine-readable storage medium of claim 35, comprising instructions that when executed by the circuitry causes the circuitry to:
forward the encoded first data stream of PDUs to a cellular protocol stack for UL data transfer over the direct path to the base station; and
forward the encoded second data stream of PDUs to a non-cellular protocol stack for UL data transfer over the remote channel of the indirect path to a relay UE.

38. The machine-readable storage medium of claim 35, comprising instructions that when executed by the circuitry causes the circuitry to:
decode a third data stream of packet data units (PDUs) for downlink (DL) data transfer over the direct path from the base station;
decode a fourth data stream of PDUs for DL data transfer over the remote channel of the indirect path from the base station via a relay UE, wherein the fourth data stream of PDUs is a duplicate of the third data stream of PDUs; and
generate a fifth data stream from the third data stream of PDUs and the fourth data stream of PDUs.

39. The machine-readable storage medium of claim 35, comprising instructions that when executed by the circuitry causes the circuitry to remove duplicate PDUs from the third data stream and the fourth data stream to generate the fifth data stream.

40. The machine-readable storage medium of claim 35, comprising instructions that when executed by the circuitry causes the circuitry to:
detect radio link failure (RLF) on the direct path or the indirect path;
generate a path failure report to indicate the RLF of the direct path or the indirect path; and
encode the path failure report for UL data transfer over the direct path to the base station when the RLF is for the indirect path; or
encode the path failure report for UL data transfer over the indirect path to the base station when the RLF is for the direct path.
